(19) United States
(12) Patent Application Publication
(10) Pub. No.: US 2021/0255765 A1
(43) Pub. Date: Aug. 19, 2021

(54) Display Control Method and Terminal

(71) Applicant: Huawei Technologies Co., Ltd., Shenzhen (CN)

(72) Inventors: Huanglingzi Liu, Shenzhen (CN); Shaolong Wang, Shenzhen (CN)

(21) Appl. No.: 17/056,568

(22) PCT Filed: May 17, 2019
(86) PCT No.: PCT/CN2019/087462

§ 371 Date: Nov. 18, 2020

(30) Foreign Application Priority Data
May 18, 2018 (CN) 201810483419.5

(51) Int. Cl. G06F 3/0488; G06F 3/0484; G06F 3/0481

(52) U.S. Cl. CPC G06F 3/04886; G06F 3/0481; G06F 3/04847; G06F 3/04842

(57) ABSTRACT

A display control method includes displaying, by a terminal, a first screen, where first display content is currently displayed on the first screen, receiving a first operation performed by a user on the first display content, storing, by the terminal, a first display record corresponding to the first display content, updating the first display content displayed on the first screen to second display content, in response to the first operation, where the first display content is different from the second display content, receiving a second operation performed by the user on the second display content, and displaying, by the terminal, the first display content on the first screen based on the first display record in response to the second operation.

### TECHNICAL FIELD

Embodiments of this application relate to the field of terminal technologies, and in particular, to a display control method and a terminal.

### BACKGROUND

With development of information technologies, an increasingly larger quantity of information and increasingly more types of information can be displayed on a screen of a terminal. The terminal may update display content on a screen in response to a refresh operation performed by a user on the display content. The refresh operation is an operation of updating the display content on the screen. Specifically, the terminal may send a content obtaining request message, for example, a get instruction, to a content provider, for example, a server, to request the content provider to provide content. When receiving returned content, the terminal displays the received content on a display apparatus of the terminal. After the refresh operation, the content displayed on the terminal may change or may not change, depending on whether the content provided by the content provider changes. After receiving the content request from the terminal, the content provider may send corresponding content to the terminal based on a previous browsing record of the terminal or according to another policy (a user preference, a current hotspot, or the like).

The screen of the terminal may even be divided into a plurality of areas (sub-screens in embodiments of this application). The terminal displays different types of information on different sub-screens, so that the user browses a plurality of types of information on one screen. For example, as shown in FIG. 1(a), HiBoard of a mobile phone may include an “application recommendation” sub-screen, a “weather” sub-screen, a “schedule” sub-screen, and the like. Similarly, the terminal may refresh display content on a sub-screen in response to a refresh operation performed by the user on the sub-screen. For example, as shown in FIG. 1(a), application icons of WeChat, Videos, QQ, and CMB are currently displayed on an “application suggestion” sub-screen 101 of the mobile phone. As shown in FIG. 1(b), in response to a tap operation performed by the user on a refresh key “Change”, the mobile phone may refresh the display content on the “application suggestion” sub-screen, and display application icons of Alipay, Stocks, Taobao, and BOC on an “application suggestion” sub-screen 102.

However, after the sub-screen is refreshed and the terminal displays refreshed display content on the sub-screen, the terminal cannot redisplay, on the sub-screen, the historical content displayed before the sub-screen is refreshed. For example, after the “application suggestion” sub-screen on HiBoard of the mobile phone is refreshed and the application icons of Alipay, Stocks, Taobao, and BOC shown in FIG. 1(b) are displayed, the application icons of WeChat, Videos, QQ, and CMB shower in FIG. 1(a) cannot he redisplayed.

### SUMMARY

Embodiments of this application provide a display control method and a terminal, to display, on a display screen of the terminal, historical display content displayed before the display screen is refreshed.

According to a first aspect, an embodiment of this application provides a display control method. The display control method includes: displaying, by a terminal, a first screen, where first display content is currently displayed on the first screen; receiving a first operation performed by a user on the first display content; storing, by the terminal, a first display record corresponding to the first display content, and updating the first display content displayed on the first screen to second display content, in response to the first operation, where the first display content is different from the second display content; receiving a second operation performed by the user on the second display content; and displaying, by the terminal, the first display content on the first screen based on the first display record in response to the second operation.

In this embodiment of this application, when displaying the first screen including the first display content, the terminal may receive the first operation performed by the user on the first display content. The terminal stores the first display record corresponding to the first display content, and updates the first display content displayed on a first sub-screen to the second display content, in response to the first operation. In this way, when receiving the second operation performed by the user on the first sub-screen on which the second display content is displayed, the terminal may redisplay the first display content based on the stored first display record in response to the second operation. To be specific, according to the method in this embodiment of this application, the terminal may display, on a display screen of the terminal, historical display content displayed before the display screen is refreshed. In this way, intelligence of the terminal can be improved, and efficient interaction between the terminal and the user can be implemented,

With reference to the first aspect, in a possible design, the first screen includes one or more sub-screens, the one or more sub-screens include a first sub-screen, and the first display content is displayed on the first sub-screen. The second display content is displayed on the first sub-screen in response to the first operation.

With reference to the first aspect, in another possible design, the first display record includes the first display content. In other words, the first display record stored in the terminal is the first display content displayed by the terminal on the first sub-screen. For example, when the first display content includes a plurality of application icons, the first display record may be the plurality of application icons. When the first display content includes a plurality of pictures recommended by the terminal to the user, the first display record may be the plurality of pictures. The terminal may directly display, on the first sub-screen in response to the second operation, the first display record (namely, the first display content) stored in the terminal.

With reference to the first aspect, in another possible design, the first display record includes an identifier of the first display content. The identifier of the first display content may be address information or index information of the first display content stored in the terminal. For example, when the first display content includes a plurality of pictures recommended by the terminal to the user, the first display record may include the identifier of the first display content. The identifier of the first display content may be address information or index information of the plurality of pictures stored in the terminal. In response to the second operation, the terminal may obtain the plurality of pictures based on the address information or the index information in the first display record, and display the plurality of pictures on the first sub-screen.

With reference to the first aspect, in another possible design, the first display record may include the first display content or an identifier of the first display content. The first display record may further include layout information of the first display content on the first screen (namely, the first sub-screen). In this implementation, in response to the second operation, the terminal may first obtain the first display content corresponding to the first display record; then typeset the obtained first display content based on the layout information included in the first display record; and finally, display the typeset first display content on the first sub-screen.

It should be noted that the layout information is optional. The first display record may not include the layout information. In this case, although the terminal may redisplay the first display content in response to the second operation, a layout of the first display content on the first sub-screen may change. For example, on the first sub-screen, a layout of the redisplayed first display content may be different from a layout of the first display content displayed for the first time.

With reference to the first aspect, in another possible design, it may be understood that to enable the terminal to redisplay the first display content on the first sub-screen in response to the second operation after refreshing display content on the first sub-screen, and to enable the terminal to further display the second display content after redisplaying the first display content, specifically, the display control method further includes: storing, by the terminal in response to the second operation, the second display record corresponding to the second display content; receiving, by the terminal, the second operation performed by the user on the first display content; and displaying, by the terminal, the second display content on the first screen based on the second display record in response to the second operation. The second display record includes the first display content or an identifier of the first display content; or the second display record includes the second display content or an identifier of the second display content, and layout information of the second display content on the first screen.

For a detailed description of the second display record, refer to the detailed description of the first display record. Details are not described again in this embodiment of this application.

With reference to the first aspect, in another possible design, display records on the first sub-screen are stored in a preset record set. The preset record set may store the display records in a time sequence. The display records on the first sub-screen include the first display record and the second display record. Correspondingly, the displaying, by the terminal, the first display content on the first screen based on the first display record in response to the second operation includes: obtaining, by the terminal, the first display record latest stored in the preset record set from the preset record set, determining the first display content based on the first display record, and displaying the first display content on the first sub-screen, in response to the second operation.

With reference to the first aspect, in another possible design, the preset record set is a preset stack. The storing, by the terminal in response to the first operation, a first display record corresponding to the first display content includes: pushing, by the terminal, the first display record onto the preset stack in response to the first operation.

With reference to the first aspect, in another possible design, a stack pointer of the preset stack points to a display record on a stack top of the preset stack in response to the first operation. In this embodiment of this application, the displaying, by the terminal, the first display content on the first screen based on the first display record in response to the second operation may include: obtaining, by the terminal, the first display record to which the stack pointer points, determining the first display content based on the first display record, and displaying the first display content on the first sub-screen, in response to the second operation. In other words, the terminal may display, in response to the second operation, display content corresponding to the display record to which the stack pointer points. It may be understood that the stack stores, in a first-in last-out manner, information pushed onto the stack. For example, the preset stack stores, in a first-in last-out mariner, the display record pushed onto the preset stack. In addition, when a new display record is pushed onto the preset stack, the stack pointer of the preset stack points to the newly pushed display record. For example, the terminal pushes the first display record onto the preset stack in response to the first operation. In this case, the first display record is located on the stack top of the preset stack, and the stack pointer currently points to the first display record located on the stack top. Then, in response to the second operation, the terminal may display the first display content corresponding to the first display record that is located on the stack top and to which the stack pointer points, and push the second display record onto the preset stack. After the terminal pushes the second display record onto the stack, the stack pointer points to the second display record located on the stack top.

With reference to the first aspect, in another possible design, the second operation is a slide operation, and as a sliding location of the slide operation changes, the stack pointer switches between the display records in the preset stack. Display content on the first sub-screen changes with switching of the stack pointer. Optionally, the terminal may further display a navigation bar in response to the second operation performed by the user on the second display content. The navigation bar may be used to guide the user to operate the terminal. In this way, performance of interaction between the terminal and the user can be improved.

With reference to the first aspect, in another possible design, after redisplaying the first display content on the first sub-screen, the terminal may receive the first operation (a refresh operation) performed by the user on the first sub-screen on which the first display content is displayed. In this case, the terminal may update, in response to the first operation, the first display content displayed on the first sub-screen to third display content. The third display content is different from the first display content, and the third display content is different from the second display content. To be specific, even if the terminal redisplays the first display content on the first sub-screen in response to the second operation, the terminal also updates the display content on the first sub-screen in response to the refresh operation (namely, the first operation), to display, on the first sub-screen, the third display content different from previously displayed display content (for example, the first display content and the second display content).

With reference to the first aspect, in another possible design, the terminal may determine, in response to the first operation, whether the terminal stores the first display record, to prevent the terminal from repeatedly storing a display record of same display content. The terminal stores the first display record only when the terminal does not store the first display record. Correspondingly, the terminal may determine, in response to the second operation, whether the terminal stores the second display record. The terminal stores the second display record only when the terminal does not store the second display record.

According to a second aspect, an embodiment of this application provides a display control method. The display control method includes: displaying, by a terminal, HiBoard, where first display content is currently displayed on HiBoard; receiving, by the terminal, a first operation performed by a user on the first display content, where the first operation is an operation of updating the first display content storing, by the terminal, a first display record corresponding to the first display content, and updating the first display content displayed on the first screen to second display content, in response to the first operation, where the first display content is different from the second display content; receiving, by the terminal, a second operation performed by the user on the second display content, where the second operation is an operation of viewing the display content displayed before the update; and displaying, by the terminal, the first display content on the first screen based on the first display record in response to the second operation.

In this embodiment of this application, when displaying HiBoard including the first display content, the terminal may receive the first operation performed by the user on the first display content. The terminal stores the first display record corresponding to the first display content, and updates the first display content displayed on a first sub-screen to the second display content, in response to the first operation. In this way, when receiving the second operation performed by the user on the first sub-screen on which the second display content is displayed, the terminal may redisplay the first display content based on the stored first display record in response to the second operation. To be specific, according to the method in this embodiment of this application, the terminal may display, on a display screen of the terminal, historical display content displayed before the display screen is refreshed. in this way, intelligence of the terminal can be improved, and efficient interaction between HiBoard of the terminal and the user can be implemented.

It should be noted that for specific descriptions in other possible designs of the second aspect, refer to the detailed descriptions in the possible designs of the first aspect. Details are not described in this embodiment of this application again.

According to a third aspect, an embodiment of this application provides a terminal. The terminal includes a display unit, an input unit, and a storage unit. The display unit is configured to display a first screen, where first display content is currently displayed on the first screen. The input unit is configured to receive a first operation performed by a user on the first display content, where the first operation is an operation of updating the first display content. The storage unit is configured to store, in response to the first operation received by the input unit, a first display record corresponding to the first display content. The display unit is further configured to update, in response to the first operation received by the input unit, the first display content displayed on the first screen to second display content, where the first display content is different from the second display content. The input unit is further configured to receive a second operation performed by the user on the second display content, where the second operation is an operation of viewing the display content displayed before the update. The display unit is further configured to display the first display content on the first screen based on the first display record in response to the second operation received by the input unit.

With reference to the third aspect, in a possible design, the first screen displayed by the display unit includes one or more sub-screens, and the one or more sub-screens include a first sub-screen; the display unit displays the first display content on the first sub-screen; and the display unit displays the second display content on the first sub-screen in response to the first operation.

With reference to the third aspect, in another possible design, the first display record includes the first display content or an identifier of the first display content. Alternatively, the first display record includes the first display content or an identifier of the first display content, and layout information of the first display content on the first screen.

With reference to the third aspect, in another possible design, the storage unit is further configured to store, in response to the second operation, a second display record corresponding to the second display content. The second display record includes the first display content or an identifier of the first display content; or the second display record includes the second display content or an identifier of the second display content, and layout information of the second display content on the first screen.

With reference to the third aspect, in another possible design, the storage unit stores a preset record set, display records on the first sub-screen are stored in the preset record set, the preset record set stores the display records in a time sequence, and the display records on the first sub-screen include the first display record. That the display unit is configured to display the first display content on the first screen based on the first display record in response to the second operation is specifically as follows: The display unit is configured to: obtain the first display record latest stored in the preset record set from the preset record set, determine the first display content based on the first display record, and display the first display content on the first sub-screen, in response to the second operation.

With reference to the third aspect, in another possible design, the preset record set is a preset stack. That the storage unit is configured to store, in response to the first operation, a first display record corresponding to the first display content is specifically as follows: The storage unit is configured to push the first display record onto the preset stack in response to the first operation.

With reference to the third aspect, in another possible design, a stack pointer of the preset stack points to a display record on a stack top of the preset stack in response to the first operation. That the display unit is configured to: obtain the first display record latest stored in the preset record set from the preset record set, determine the first display content based on the first display record, and display the first display content on the first sub-screen, in response to the second operation is specifically as follows: The display unit is configured to: obtain the first display record to which the stack pointer points, determine the first display content based on the first display record, and display the first display content on the first sub-screen, in response to the second operation. The storage unit is configured to push the second display record onto the preset stack in response to the second operation.

With reference to the third aspect, in another possible design, the second operation is a. slide operation, and as a sliding location of the slide operation changes, the stack pointer switches between the display records in the preset stack. Display content on the first sub-screen changes with switching of the stack pointer.

With reference to the third aspect, in another possible design, the input unit is further configured to: after the display unit displays the first display content on the first screen based on the first display record in response to the second operation, receive the first operation performed by the user on the first display content. The display unit is further configured to update the first display content to third display content in response to the first operation. The third display content is different from the first display content, and the third display content is different from the second display content.

With reference to the third aspect, in another possible design, that the storage unit is configured to store, in response to the first operation, a first display record corresponding to the first display content is specifically as follows: The storage unit is configured to store the first display record in response to the first operation when the storage unit does not store the first display record.

According to a fourth aspect, an embodiment of this application provides a terminal. The terminal includes a display unit, an input unit, and a storage unit. The display unit is configured to display HiBoard, where first display content is currently displayed on HiBoard. The input unit is configured to receive a first operation performed by a user on the first display content, where the first operation is an operation of updating the first display content. The storage unit is configured to store, in response to the first operation received by the input unit, a first display record corresponding to the first display content. The display unit is further configured to update, in response to the first operation received by the input unit, the first display content displayed on the first screen to second display content, where the first display content is different from the second display content. The input unit is further configured to receive a second operation performed by the user on the second display content, where the second operation is an operation of viewing the display content displayed before the update. The display unit is further configured to display the first display content on the first screen based on the first display record in response to the second operation received by the input unit.

It should be noted that for other function descriptions of the display unit, the input unit, and the storage unit in the fourth aspect, refer to the detailed descriptions in the possible designs of the third aspect. Details are not described in this embodiment of this application again.

According to a fifth aspect, an embodiment of this application provides a terminal. The terminal includes one or more processors, a memory, and a display. The memory and the display are coupled to the processor, The display is configured to: display a screen and receive a touch operation of a user. The memory includes a nonvolatile storage medium, and the memory is configured. to store computer program code. The computer program code includes a computer instruction. When the processor executes the computer instruction, the display is configured to display a first screen, where first display content is currently displayed on the first screen; the processor is configured to: receive a first operation performed by the user on the first display content, where the first operation is an operation of updating the first display content; and store, in the memory in response to the first operation, a first display record corresponding to the first display content; the processor is configured to update, in response to the first operation, the first display content displayed by the display on the first screen to second display content, where the first display content is different from the second display content; the processor is further configured to receive a second operation performed by the user on the second display content, where the second operation is an operation of viewing the display content displayed before the update; and the processor is further configured to control, based on the first display record in response to the second operation, the display to display the first display content on the first screen.

With reference to the fifth aspect, in a possible design, the first screen displayed by the display includes one or more sub-screens, and the one or more sub-screens include a first sub-screen; the first display content is displayed on the first sub-screen; and the second display content is displayed on the first sub-screen in response to the first operation.

With reference to the fifth aspect, in another possible design, the first display record includes the first display content or an identifier of the first display content. Alternatively, the first display record includes the first display content or an identifier of the first display content, and layout information of the first display content on the first screen.

With reference to the fifth aspect, in another possible design, the processor is further configured to store, in the memory in response to the second operation, a second display record corresponding to the second display content. The second display record includes the first display content or an identifier of the first display content; or the second display record includes the second display content or an identifier of the second display content, and layout information of the second display content on the first screen.

With reference to the fifth aspect, in another possible design, the memory stores a preset record set, display records on the first sub-screen are stored in the preset record set, the preset record set stores the display records in a time sequence, and the display records on the first sub-screen include the first display record. That the processor is configured to control, based on the first display record in response to the second operation, the display to display the first display content on the first screen is specifically as follows: The processor is configured to: obtain the first display record latest stored in the preset record set from the preset record set, determine the first display content based on the first display record, and control the display to display the first display content on the first sub-screen, in response to the second operation.

With reference to the fifth aspect, in another possible design, the preset record set stored in the memory is a preset stack. That the processor is configured to store, in the memory in response to the first operation, a first display record corresponding to the first display content is specifically as follows: The processor is configured to push, in response to the first operation, the first display record onto the preset stack stored in the memory.

With reference to the fifth aspect, in another possible design, a stack pointer of the preset stack stored in the memory points to a display record on a stack top of the preset stack in response to the first operation. That the processor is configured to: obtain, the first display record latest stored in the preset record set from the preset record set stored in the memory, determine the first display content based on the first display record, and control the display to display the first display content on the first sub-screen, in response to the second operation is specifically as follows: The processor is configured to: in response to the second operation, obtain, by the terminal, the first display record to which the stack pointer of the preset stack stored in the memory points, determine the first display content based on the first display record, and control the display to display the first display content on the first sub-screen; and push the second display record onto the preset stack stored in the memory.

With reference to the fifth aspect, in another possible design, the second operation is a slide operation, and as a sliding location of the slide operation changes, the stack pointer switches between the display records in the preset stack. Display content on the first sub-screen changes with switching of the stack pointer.

With reference to the fifth aspect, in another possible design, after controlling, based on the first display record in response to the second operation, the display to display the first display content on the first screen, the processor receives the first operation performed by the user on the first display content; and controls, in response to the first operation, the display to update the first display content to third display content. The third display content is different from the first display content, and the third display content is different from the second display content.

With reference to the fifth aspect, in another possible design, that the processor is configured to store, in the memory in response to the first operation, a first display record corresponding to the first display content is specifically as follows: The processor is configured to store the first display record in the memory in response to the first operation when the memory does not store the first display record.

According to a sixth aspect, an embodiment of this application provides a terminal. The terminal includes one or more processors, a memory, and a display. The memory and the display are coupled to the processor. The display is configured to: display a screen and receive a touch operation of a user. The memory includes a nonvolatile storage medium, and the memory is configured to store computer program code. The computer program code includes a computer instruction. When the processor executes the computer instruction,

The display is configured to display HiBoard, where first display content is currently displayed on HiBoard. The processor is configured to: receive a first operation performed by the user on the first display content, where the first operation is an operation of updating, the first display content; store, in the memory, a first display record corresponding to the first display content, and update the first display content displayed by the display on the first screen to second display content, in response to the first operation, where the first display content is different from the second display content; receive a second operation performed by the user on the second display content, where the second operation is an operation of viewing the display content displayed before the update; and control, based on the first display record in response to the second operation, the display to display the first display content on the first screen.

It should be noted that for other function descriptions of the processor, the memory, and the display in the sixth aspect, refer to the detailed descriptions in the possible designs of the fifth aspect. Details are not described in this embodiment of this application again.

According to a seventh aspect, an embodiment of this application provides a computer storage medium. The computer storage medium includes a computer instruction, and when the computer instruction is run on a terminal, the terminal is enabled to perform the display control method according to the first aspect or the second aspect and the possible designs of the first aspect or the second aspect.

According to an eighth aspect, an embodiment of this application provides a computer program product. When the computer program product is run on a computer, the computer is enabled to perform the display control method according to the first aspect or the second aspect and the possible designs of the first aspect or the second aspect.

In addition, for technical effects brought by the second aspect to the sixth aspect and any design of the second aspect to the sixth aspect and technical effects brought by the seventh aspect and the eighth aspect, refer to the technical effects brought by the first aspect and the second aspect and different designs of the first aspect and the second aspect. Details are not described in this embodiment of this application again.

### BRIEF DESCRIPTION OF DRAWINGS

FIG. 1(a) and FIG. 1(b) are a schematic diagram 1 of an instance of a display screen according to an embodiment of this application;

FIG. 2 is a schematic diagram of a hardware structure of a mobile phone according to an embodiment of this application;

FIG. 3 is a flowchart 1 of a display control method according to an embodiment of this application;

FIG. 4(a) to FIG. 4(d) are a schematic diagram 2 of an instance of a display screen according to an embodiment of this application;

FIG. 5(a) and FIG. 5(b) are a schematic diagram 3 of an instance of a display screen according to an embodiment of this application;

FIG. 6(a) and FIG. 6(b) are a schematic diagram 4 of an instance of a display screen according to an embodiment of this application;

FIG. 7(a) to FIG. 7(d) are a schematic diagram 5 of an instance of a display screen according to an embodiment of this application;

FIG. 8A is a flowchart 2 of a display control method according to an embodiment of this application;

FIG. 8B(1) to FIG. 8B(3) are a schematic diagram 6 of an instance of a display screen according to an embodiment of this application;

FIG. 9(a) to FIG. 9(j) are a schematic diagram 1 of an instance in which a preset record set stores a display record according to an embodiment of this application;

FIG. 10(a-1) to FIG. 10(a-3) and FIG. 10(b-1) to FIG. 10(b-3) are a schematic diagram 1 of an instance in which a preset stack stores a display record according to an embodiment of this application;

FIG. 11(a-1) FIG. 11(a-2) and FIG. 11(b-1) and FIG. 11(b-2) are a schematic diagram 2 of an instance in which a preset stack stores a display record according to an embodiment of this application;

FIG. 12A is a flowchart 3 of a display control method according to an embodiment of this application;

FIG. 12B(a-1) and FIG. 12B(a-2) and FIG. 12B(b-1) and FIG. 12B(b-2) are a schematic diagram 3 of an instance in which a preset stack stores a display record according to an embodiment of this application;

FIG. 13(a-1) to FIG. 13(a-4) and FIG. 13(b-1) to FIG. 13(b-4) are a schematic diagram 4 of an instance in which a preset stack stores a display record according to an embodiment of this application;

FIG. 14(a-1) to FIG. 14(a-3) and FIG. 14(b-1) to FIG. 14(b-4) are a schematic diagram 5 of an instance in which a preset stack stores a display record according to an embodiment of this application;

FIG. 15(a) to FIG. 15(d) are a schematic diagram 7 of an instance of a display screen according to an embodiment of this application;

FIG. 16(a) to FIG. 16(c) are a schematic diagram 1 of an instance in which a preset stack corresponding to the display screen shown in FIG. 15(a) to FIG. 15(d) stores a display record;

FIG. 17(a) to FIG. 17(c) are a schematic diagram 8 of an instance of a display screen according to an embodiment of this application;

FIG. 18A(1) to FIG. 18A(3) are a schematic diagram of an instance in which a preset stack corresponding to the display screen shown in FIG. 17(a) to FIG. 17(c) stores a display record;

FIG. 18B(1) to FIG. 18B(3) are a schematic diagram 9 of an instance of a display screen according to an embodiment of this application;

FIG. 19(a) and FIG. 19(b) are a schematic diagram 1 of an instance in which a preset stack corresponding to the display screen shown in FIG. 18B(1) to FIG. 18B(3) stores a display record;

FIG. 20(a) and FIG. 20(b) are a schematic diagram 2 of an instance in which a preset stack corresponding to the display screen shown in FIG. 18B(1) to FIG. 18B(3) stores a display record;

FIG. 21(a) to FIG. 21(c) are a schematic diagram 10 of an instance of a display screen according to an embodiment of this application;

FIG. 22(a) to FIG. 22(c) are a schematic diagram 1 of an instance in which a preset stack corresponding to the display screen shown in FIG. 21(a) to FIG. 21(c) stores a display record;

FIG. 23(a) to FIG. 23(h) are a schematic diagram 2 of an instance in which a preset record set stores a display record according to an embodiment of this application;

FIG. 24(a-1) to FIG. 24(a-3) and FIG. 24(b-1) to FIG. 24(b-3) are a schematic diagram 6 of an instance in which a preset stack stores a display record according to an embodiment of this application;

FIG. 25(a) to FIG. 25(c) are a schematic diagram 2 of an instance in which a preset stack corresponding to the display screen shown in FIG. 15(a) to FIG. 15(d) stores a display record;

FIG. 26(a) to FIG. 26(c) are a schematic diagram 2 of an instance in which a preset stack corresponding to the display screen shown in FIG. 21(a) to FIG. 21(c) stores a display record;

FIG. 27 is a schematic structural composition diagram 1 of a terminal according to an embodiment of this application; and

FIG. 28 is a schematic structural composition diagram 2 of a terminal according to an embodiment of this application.

### DESCRIPTION OF EMBODIMENTS

The following terms “first” and “second” are merely intended for description, and shall not be understood as an indication or implication of relative importance or implicit indication of a quantity of indicated technical features. Therefore, a feature limited by “first” or “second” may explicitly or implicitly include one or more features. In the descriptions of the embodiments of this application, unless otherwise stated, “a plurality of” means two or more than two.

Embodiments of this application provide a display control method and a terminal. The method may be applied to the terminal. The method may be applied to a process in which the terminal updates a first sub-screen in a first screen. According to the method provided in the embodiments of this application, after updating display content on the first sub-screen, the terminal may display, in response to an operation of a user, the display content displayed before the update on the first sub-screen. In this way, intelligence of the terminal can be improved, and efficient interaction between the terminal and the user can be implemented.

The first screen may be a display screen of a first application. The first application may be any application installed in the terminal. The first application may be an embedded application (namely, a system application of the terminal) of the terminal or a downloadable application. The embedded application, namely, the system application, is an application provided as a part of the terminal. For example, the system application may include HiBoard, an application store, and the like. The downloadable application is an application that may provide an internet protocol multimedia subsystem (IMS) connection of the downloadable application. The downloadable application may be an application preinstalled in the terminal or may he a third-party application that may be downloaded by a user and installed in the terminal. For example, the downloadable application may include Taobao, Youku, and the like.

The first sub-screen in the embodiments of this application may be an entire screen of the first screen. Alternatively, the first sub-screen is a partial screen of the first screen. When the first sub-screen is the partial screen of the first screen, the first screen may include one or more first sub-screens.

It should be noted that the terminal in the embodiments of this application may be a device such as a mobile phone, a tablet computer, a desktop computer, a laptop computer, a handheld computer, a notebook computer, an ultra-mobile personal computer (UMPC), a netbook, a cellular phone, a personal digital assistant (PDA), a wearable electronic device (for example, a smartwatch), a tablet computer, an augmented reality (AR)/virtual reality (VR) device, or an in-vehicle computer. A specific form of the device is not specially limited in the embodiments of this application.

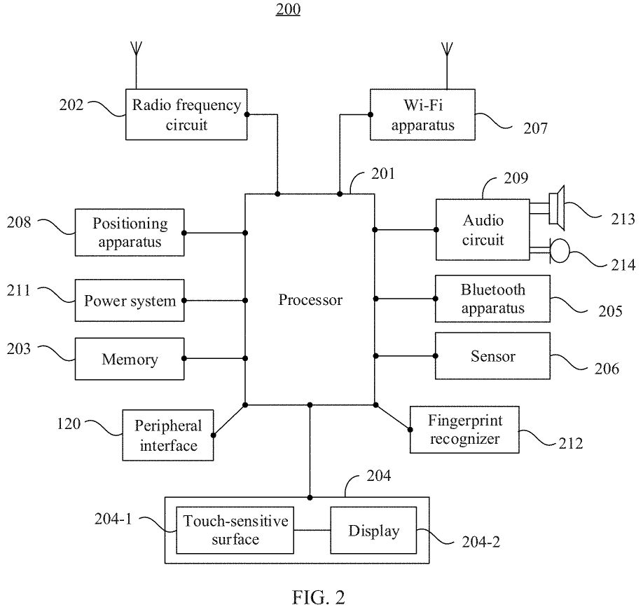

Referring to FIG. 2, an example in which a terminal is a mobile phone 200 is used in an embodiment of this application to describe the terminal provided in this embodiment of this application. A person skilled in the art may understand that the mobile phone 200 shown in FIG. 2 is merely an example, and does not constitute a limitation on the mobile phone 200. In addition, the mobile phone 200 may have more or fewer components than those shown in the figure, or may combine two or more components, or may have different component configurations. The components shown in FIG. 2 may be implemented in hardware including one or more signal processors and/or application-specific integrated circuits, software, or a combination of hardware and software.

As shown in FIG. 2, the mobile phone 200 may specifically include components such as a processor 201, a radio frequency (Radio Frequency, RF) circuit 202, a memory 203, a touchscreen 204, a Bluetooth apparatus 205, one or more sensors 206, a wireless fidelity (Wireless Fidelity, Wi-Fi) apparatus 207, a positioning apparatus 208, an audio circuit 209, a peripheral interface 120, a power system 211, and a fingerprint recognizer 212. These components may perform communication by using one or more communications buses or signal cables (not shown in FIG. 2).

The following describes the components of the mobile phone 200 in detail with reference to FIG. 2.

The processor 201 is a control center of the mobile phone 200. The processor 201 is connected to parts of the mobile phone 200 by using various interfaces and cables, and performs various functions of the mobile phone 200 and data processing by running or executing an application (Application, App) program stored in the memory 203, and invoking data and an instruction that are stored in the memory 203. In some embodiments, the processor 201 may include one or more processing units. The processor 201 may further integrate an application processor and a modem processor. The application processor mainly processes an operating system, a user interface, an application program, and the like. The modem processor mainly processes wireless communication. It should be understood that the modem processor may not be integrated into the processor 201. Fax example, the processor 201 may be a chip Kirin 960 manufactured by Huawei Technologies Co., Ltd.

The radio frequency circuit 202 may be configured to: receive and send radio signals in an information receiving and sending process or a call process. Specifically, after receiving downlink data from a base station, the radio frequency circuit 202 may send the downlink data to the processor 201 for processing. In addition, the radio frequency circuit 202 sends related uplink data to the base station. Usually, the radio frequency circuit 202 includes but is not limited to an antenna, at least one amplifier, a transceiver, a coupler, a low noise amplifier, a duplexer, and the like. In addition, the radio frequency circuit 202 may further communicate with another device through wireless communication. The wireless communication may use any communications standard or protocol, including but not limited to a global system for mobile communications, a general packet radio service, code division multiple access, wideband code division multiple access, long term evolution, an email, a short message service, and the like.

The memory 203 is configured to store the application program and the data. The processor 201 performs various functions of the mobile phone 200 and data processing by running the application program and the data that are stored in the memory 203. The memory 203 mainly includes a program storage area and a data storage area. The program storage area may store an operating system, and an application program required by at least one function (for example, a sound playing function or an image playing function). The data storage area may store data (for example, audio data or a phone book) created based on use of the mobile phone 200. In addition, the memory 203 may include a high-speed random access memory, and may further include a nonvolatile memory such as a magnetic disk storage device, a flash memory device, or another volatile solid-state storage device. The memory 203 may store various operating systems such as an iOS® operating system developed by Apple and an Android® operating system developed by Google.

The touchscreen 204 may include a touch-sensitive surface 204-1 and a display 204-2. The touch-sensitive surface 204-1 (for example, a touch panel) may collect a touch event (for example, an operation performed by a user of the mobile phone 200 on the touch-sensitive surface 204-1 or near the touch-sensitive surface 204-1 by using any proper object such as a finger or a stylus) performed by the user on or near the touch-sensitive screen 204-1, and send collected touch information to another device, for example, the processor 201. The touch event performed by the user near the touch-sensitive surface 204-1 may be referred to as a floating touch. The floating touch may mean that the user does not need to directly touch the touchpad for selecting, moving, or dragging an object (for example, an icon), and the user only needs to be near the terminal to perform a desired function. In an application scenario of the floating touch, terms such as “touch” and “contact” do not implicitly mean to directly touch the touchscreen, but to be near or close to the touchscreen. The touch-sensitive surface 204-1 on which the floating touch can be performed may be implemented in a capacitive type, an infrared photoreceptor type, an ultrasonic wave type, or the like. The touch-sensitive surface 204-1 may include two parts: a touch detection apparatus and a touch controller. The touch detection apparatus detects a touch orientation of the user, detects a signal generated by a touch operation, and transmits the signal to the touch controller. The touch controller receives touch information from the touch detection apparatus, transforms the touch information into contact coordinates, and then sends the contact coordinates to the processor 201. The touch controller may further receive an instruction sent by the processor 201, and execute the instruction. In addition, the touch-sensitive surface 204-1 may be implemented in a plurality of types such as a resistive type, a capacitive type, an infrared type, and a surface acoustic wave type. The display 204-2 may be configured to display information entered by the user or information provided for the user, and various menus of the mobile phone 200. The display 204-2 may be configured in a form such as a liquid crystal display or an organic light emitting diode. The touch-sensitive surface 204-1 may cover the display 204-2. After detecting the touch event on or near the touch-sensitive surface 204-1, the touch-sensitive surface 204-1 transmits the touch event to the processor 201 to determine a type of the touch event. Then, the processor 201 may provide corresponding visual output on the display 204-2 based on the type of the touch event. Although in FIG. 2, the touch-sensitive surface 204-1 and the display 204-2 are used as two independent components to implement input and output functions of the mobile phone 200, in some embodiments, the touch-sensitive surface 204-1 and the display 204-2 may be integrated to implement the input and output functions of the mobile phone 200. It may be understood that the touchscreen 204 is formed by stacking a plurality of layers of materials. Only the touch-sensitive surface (layer) and the display (layer) are displayed in this embodiment of this application, and another layer is not recorded in this embodiment of this application. In addition, in some other embodiments of this application, the touch-sensitive surface 204-1 may cover the display 204-2, and a size of the touch-sensitive surface 204-1 is greater than a size of the display 204-2. Therefore, the display 204-2 is completely covered by the touch-sensitive surface 204-1. Alternatively, the touch-sensitive surface 204-1 may be configured on a front side of the mobile phone 200 in a full panel form. In other words, any touch performed by the user on the front side of the mobile phone 200 can be sensed by the mobile phone 200. In this way, full touch control experience on the front side of the mobile phone 200 can be implemented. In some other embodiments, the touch-sensitive surface 204-1 is configured on a front side of the mobile phone 200 in a full panel form, and the display 204-2 may also be configured on the front side of the mobile phone 200 in a full panel form. In this way, a bezel-less structure can be implemented on the front side of the mobile phone 200.

The mobile phone 200 may further include the Bluetooth apparatus 205, configured to exchange data between the mobile phone 200 and another short-distance terminal (for example, a mobile phone or a smartwatch). In this embodiment of this application, the Bluetooth apparatus may be an integrated circuit, a Bluetooth chip, or the like.

The mobile phone 200 may further include at least one sensor 206, such as a light sensor, a motion sensor, and another sensor. Specifically, the light sensor may include an ambient light sensor and a proximity sensor. The ambient light sensor may adjust luminance of the display of the touchscreen 204 based on intensity of ambient light. The proximity sensor may power off the display when the mobile phone 200 moves to an ear. As one type of the motion sensor, an accelerometer sensor may detect acceleration values in all directions (usually on three axes). The accelerometer sensor may detect a value and a direction of gravity when the accelerometer sensor is stationary, and may be used in an application for recognizing a posture (such as switching between a landscape mode and a portrait mode, a related game, or magnetometer posture calibration) of the mobile phone 200, a function related to vibration recognition (such as a pedometer or a knock), or the like. For another sensor that may be further configured on the mobile phone 200, such as a gyroscope, a barometer, a hygrometer, a thermometer, or an infrared sensor, details are not described herein.

In the embodiments of this application, the mobile phone 200 may further have a fingerprint recognition function. For example, the fingerprint recognizer 212 may be configured on a rear side (for example, below a rear-facing camera) of the mobile phone 200, or the fingerprint recognizer 212 may be configured on a front side (for example, below the touchscreen 204, or on a home screen button of the mobile phone 200) of the mobile phone 200. In addition, the fingerprint recognizer 212 may be configured on the touchscreen 204 to implement the fingerprint recognition function. In other words, the fingerprint recognizer 212 may be integrated with the touchscreen 204 to implement the fingerprint recognition function of the mobile phone 200. In this case, the fingerprint recognizer 212 may be configured on the touchscreen 204 as a part of the touchscreen 204, or may be configured on the touchscreen 204 in another manner. In addition, the fingerprint recognizer 212 may be further implemented as a full-panel fingerprint recognizer. Therefore, the touchscreen 204 may be considered as a panel on which a fingerprint may be collected at any location. In some embodiments, the fingerprint recognizer 212 may process a collected fingerprint. For example, the fingerprint recognizer 212 may perform processing such as fingerprint verification on the collected fingerprint. The fingerprint recognizer 212 may further send a fingerprint verification processing result (for example, whether the fingerprint verification succeeds) to the processor 201, so that the processor 201 makes a corresponding response based on the received fingerprint verification result. In some other embodiments, the fingerprint recognizer 212 may alternatively send a collected fingerprint to the processor 201, so that the processor 201 processes the fingerprint (for example, verifies the fingerprint). A main component of the fingerprint recognizer 212 in this embodiment of this application is a fingerprint sensor. The fingerprint sensor may use any type of sensing technology, including but not limited to an optical sensing technology, a capacitive sensing technology, a piezoelectric sensing technology, an ultrasonic sensing technology, or the like.

The Wi-Fi apparatus 207 is configured to provide the mobile phone 200 with network access that complies with a Wi-Fi related standard or protocol. The mobile phone 200 may access a Wi-Fi access point by using the Wi-Fi apparatus 207, to help the user receive and send emails, browse a web page, access streaming media, and the like. The Wi-Fi apparatus 207 provides wireless broadband internet access for the user. In some other embodiments, the Wi-Fi apparatus 207 may alternatively be used as a Wi-Fi wireless access point, and may provide network access for another terminal.

The positioning apparatus 208 is configured to provide a geographical location for the mobile phone 200. It may be understood that the positioning apparatus 208 may be specifically a receiver of a positioning system such as a global positioning system (Global Positioning System, GPS) or a BeiDou navigation satellite system. After receiving the geographical location sent by the positioning system, the positioning apparatus 208 sends the information to the processor 201 for processing, or sends the information to the memory 203 for storage. In some other embodiments, the positioning apparatus 208 may be a receiver of an assisted global positioning system (Assisted Global Positioning System, AGPS). The AGPS runs in a manner in which GPS positioning is performed with specific assistance. The AGPS may use a signal of a base station together with a GPS satellite signal, to speed up positioning performed by the mobile phone 200. In the AGPS, the positioning apparatus 208 may obtain positioning assistance through communication with an assisted positioning server (for example, a positioning server of the mobile phone 200). The AGPS system serves as an assisted server to assist the positioning apparatus 208 in completing ranging and positioning services. In this case, the assisted positioning server communicates with the positioning apparatus 208 (namely, a GPS receiver) of the terminal such as the mobile phone 200 by using a wireless communications network, to provide positioning assistance.

The audio circuit 209, a speaker 213, and a microphone 214 may provide an audio interface between the user and the mobile phone 200. The audio circuit 209 may convert received audio data into an electrical signal and then transmit the electrical signal to the speaker 213, and the speaker 213 converts the electrical signal into an audio signal for output. In addition, the microphone 214 converts a collected sound signal into an electrical signal, and the audio circuit 209 receives the electrical signal and converts the electrical signal into audio data and then outputs the audio data to the RF circuit 202, to send the audio data to, for example, another mobile phone, or outputs the audio data to the memory 203 for further processing.

The peripheral interface 120 is configured to provide various interfaces for an external input/output device (for example, a keyboard, a mouse, an external display, an external memory, or a subscriber identification module card). For example, the peripheral interface 120 is connected to the mouse by using a universal serial bus interface, and the peripheral interface 120 is connected, by using a metal contact on a card slot of the subscriber identification module (SIM) card, to the subscriber identity module card provided by a telecommunications operator. The peripheral interface 120 may be configured to couple the external input/output peripheral device to the processor 201 and the memory 203.

The mobile phone 200 may further include the power apparatus 211 (for example, a battery and a power management chip) that supplies power to the components. The battery may be logically connected to the processor 201 by using the power management chip, to implement functions such as charging management, discharging management, and power consumption management by using the power apparatus 211.

Although not shown in FIG. 2, the mobile phone 200 may further include a camera (a front-facing camera and/or a rear-facing camera), a flash, a micro projection apparatus, a near field communication (Near Field Communication, NFC) apparatus, and the like. Details are not described herein.

All methods in the following embodiments may be implemented on the mobile phone 200 having the foregoing hardware structure.

The display control method provided in this application may be performed by a display apparatus. The display apparatus may be any one of the foregoing terminals (for example, the display apparatus may be the mobile phone 200 shown in FIG. 2). Alternatively, the display apparatus may be a central processing unit (English: Central Processing Unit, CPU for short) of the terminal, or a control module that is in the terminal and that is configured to perform the display control method. In this embodiment of this application, the display control method provided in this embodiment of this application is described by using an example in which the terminal performs the display control method.

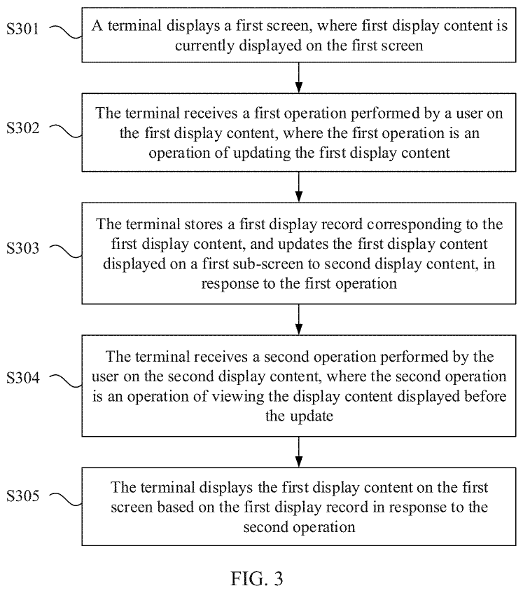

An embodiment of this application provides a display control method. As shown in FIG. 3, the display control method includes S301 to S305.

S301: A terminal displays a first screen. First display content is currently displayed on the first screen.

In this embodiment of this application, the first screen may include one or more sub-screens, and the one or more sub-screens may include a first sub-screen and a second sub-screen. The first sub-screen is different from the second sub-screen. Alternatively, the one or more sub-screens may further include a third sub-screen. The third sub-screen is different from the second sub-screen. The third sub-screen is different from the first sub-screen. In this embodiment of this application, the method in this embodiment of this application is subsequently described by using an example in which the first display content is displayed on the first sub-screen.

The first screen is a display screen of a first application. For example, the first application may be HiBoard, an application store, Taobao, iQIYI, or the like.

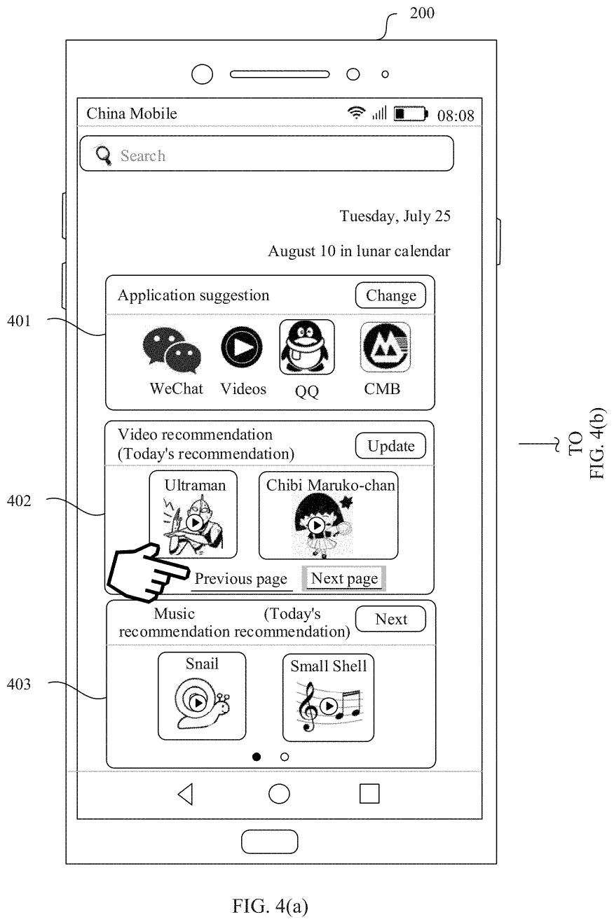

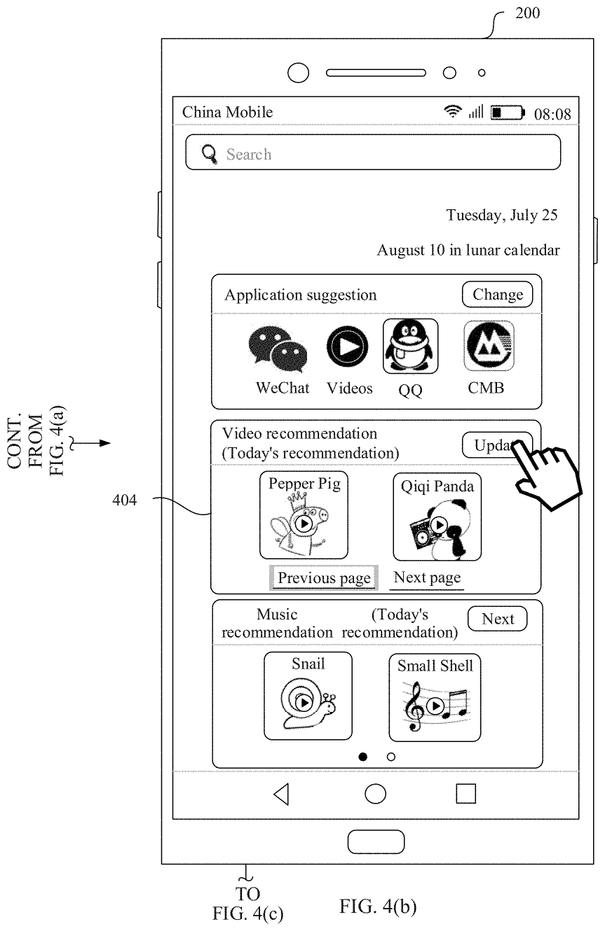

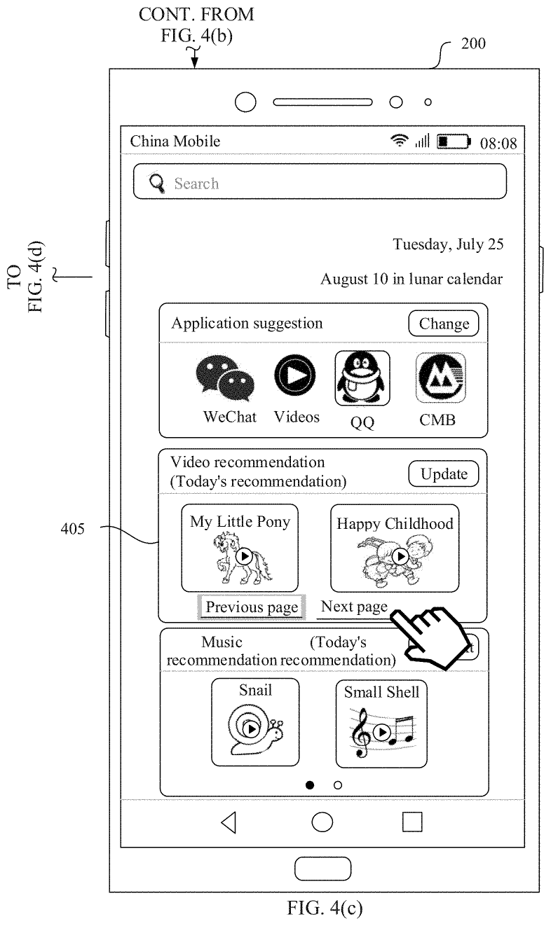

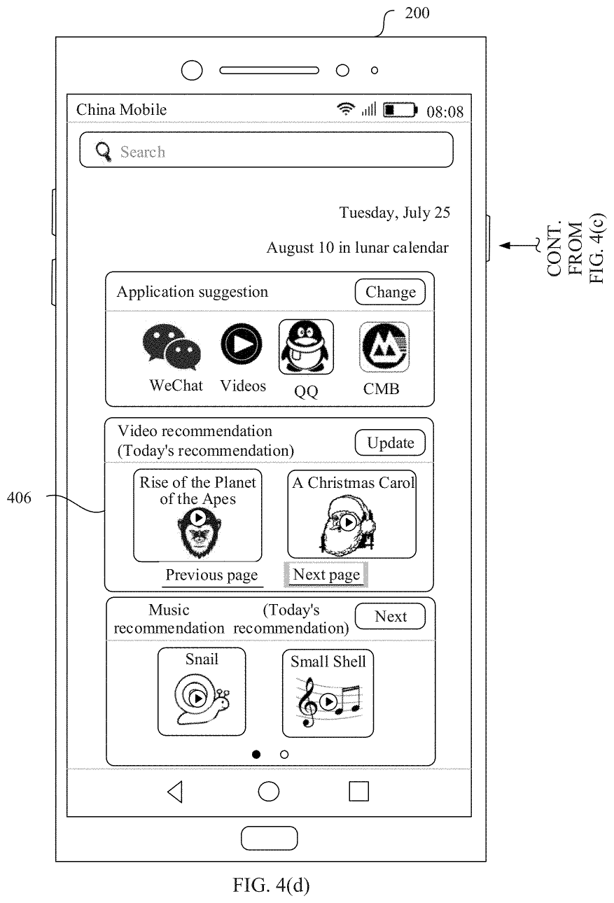

For example, in an application scenario (1), the first application is HiBoard, and the first screen is a display screen of HiBoard. For example, as shown in FIG. 4(a), HiBoard of a mobile phone includes three sub-screens 401, 402, and 403: an “application suggestion” sub-screen 401 shown in FIG. 4(a), a “video recommendation” sub-screen 402 shown in FIG. 4(a), and a “music recommendation” sub-screen 403 shown in FIG. 4(a).

In this embodiment of this application, the first display content is content displayed before the first sub-screen is refreshed. For example, in the application scenario (1), first display content displayed before the “application suggestion” sub-screen shown in FIG. 4(a) is refreshed includes application icons of WeChat, Videos, QQ, and CMB. For another example, first display content displayed before a “video recommendation” sub-screen 404 shown in FIG. 4(b) is refreshed and first display content displayed before the “video recommendation” sub-screen 402 shown in FIG. 4(a) is refreshed each include recommendation items of Peppa Pig, Qiqi Panda, Ultraman, and Chibi Maruko-chin.

S302: The terminal receives a first operation performed by a user on the first display content. The first operation is an operation of updating the first display content.

S303: The terminal stores a first display record corresponding to the first display content, and updates the first display content displayed on the first sub-screen to second display content, in response to the first operation.

The terminal may store the first display record in a cache or memory of the terminal. This is not limited in this embodiment of this application. It should be noted that the first display content is different from the second display content.

In this embodiment of this application, the first operation is used to instruct the terminal to refresh display content on the first sub-screen, in other words, instruct the terminal to update the first display content.

In this embodiment of this application, the first display record includes the first display content or an identifier of the first display content. Alternatively, the first display record includes the first display content or an identifier of the first display content, and layout information of the first display content on the first screen.

In an implementation, the first sub-screen in the first screen is used as an example. The first sub-screen may include a refresh key, or a refresh option. The refresh key, the refresh key, or the refresh option is used to control the terminal to refresh the display content on the first sub-screen, in other words, control the terminal to update the first display content. For example, the refresh key, the refresh key, or the refresh option may be “Change”, “Update”, “Others”, or the like. This is not limited in this embodiment of this application. For example, the first sub-screen includes the refresh key. The first operation performed by the user on the first display content may be an operation performed by the user on the refresh key on the first sub-screen. For example, the first operation may be any operation such as a tap operation, a double-tap operation, or a touch and hold operation performed by the user on the refresh key.

In another implementation, the first operation may be a first preset gesture entered by the user on the first sub-screen. The first preset gesture may be used to instruct the terminal to refresh the display content on the first sub-screen. For example, the first preset gesture may be any gesture such as a pull-down gesture, a top-down slide gesture, a left-to-right slide gesture, a bottom-up slide gesture, a circular gesture (a circle-similar gesture), a semi-circular gesture, or an S-shaped gesture entered by the user on the first screen or the first sub-screen.

In some embodiments, the first screen may include only one sub-screen, for example, the first sub-screen. The first operation may be an operation performed by the user on the first sub-screen. The first operation is used to refresh the display content on the first sub-screen.

In some other embodiments, the first screen may include a plurality of sub-screens. For example, the first screen may include the first sub-screen, the second sub-screen, and the third sub-screen. When the first screen includes the plurality of sub-screens, specific functions of the first operation include the following three implementations (1) to (3):

### Implementation (1)

The first operation may be an operation performed by the user on any sub-screen (for example, the first sub-screen) in the first screen. The first operation is used to refresh the display content on the first sub-screen. In the implementation (1), in response to the first operation, the terminal needs to refresh only the display content on the first sub-screen on which the first operation is performed, but does not need to refresh display content on another sub-screen in the first screen.

For example, in the application scenario (1), it is assumed that the first operation is a tap operation performed by the user on a refresh key on a sub-screen in HiBoard. In HiBoard of the mobile phone shown in FIG. 4(b), the first display content displayed before the “video recommendation” sub-screen is refreshed includes the recommendation items of Peppa Pig, Qiqi Panda, Ultraman, and Chibi Maruko-chan. The mobile phone receives a tap operation performed by the user on a refresh key “Update” shown in FIG. 4(b). In response to the tap operation, the mobile phone may refresh the display content on the “video recommendation” sub-screen, and display second display content on the “video recommendation” sub-screen. The second display content is content displayed after the first sub-screen is refreshed. For example, the second display content displayed after the “video recommendation” sub-screen 404 shown in FIG. 4(b) is refreshed includes a recommendation item of My Little Pony and a recommendation item of Happy Childhood on a “video recommendation” sub-screen 405 shown in FIG. 4(c), and a recommendation item of Rise of the Planet of the Apes and a recommendation item of A Christmas Carol on a “video recommendation” sub-screen 406 shown in FIG. 4(d).

It should be noted that the first operation is the tap operation performed by the user on the refresh key “Update” shown in FIG. 4(b). It can be learned by comparing FIG. 4(b) with FIG. 4(c) and FIG. 4(d) that the mobile phone 200 refreshes only the display content on the “video recommendation” sub-screen in response to the tap operation. However, display content on an “application suggestion” sub-screen and a “music recommendation” sub-screen does not change.

### Implementation (2)

The first operation may be an operation performed by the user on the first screen. The first operation is used to refresh display content on all sub-screens in the first screen. In the implementation (2), the terminal may refresh, in response to the first operation, the display content on all the sub-screens in the first screen.

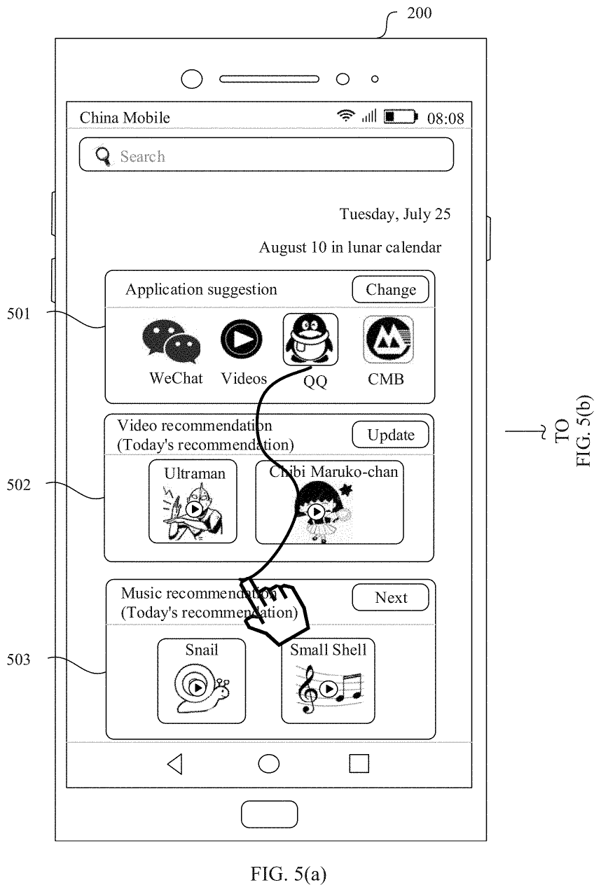

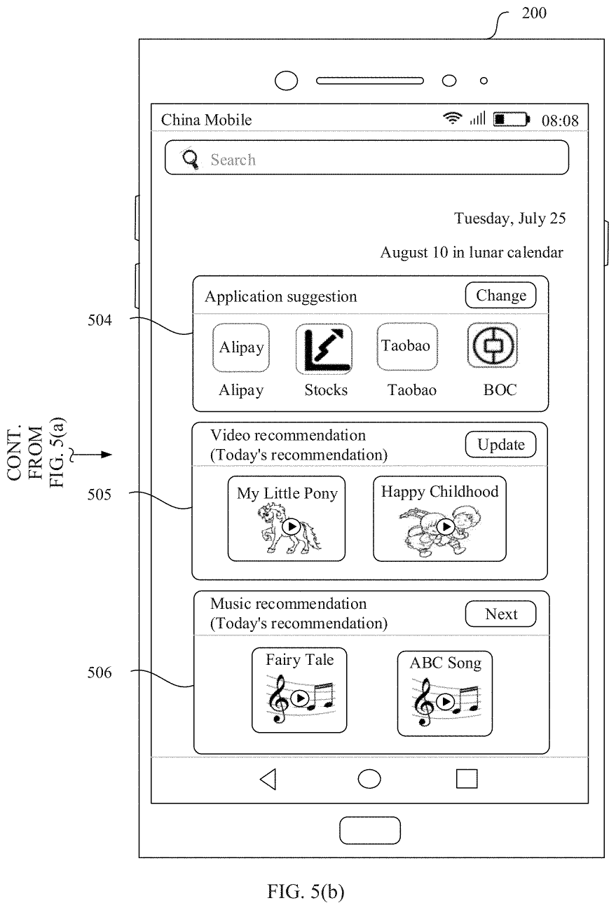

For example, in the application scenario (1), it is assumed that the first operation is a first preset gesture such as an S-shaped gesture entered by the user on HiBoard. In HiBoard of the mobile phone shown in FIG. 5(a), first display content displayed before an “application suggestion” sub-screen 501 is refreshed includes application icons of WeChat, Videos, QQ, and CMB, first display content displayed before a “video recommendation” sub-screen 502 is refreshed includes recommendation items of Ultraman and Chibi Maruko-chan, and first display content displayed before a “music recommendation” sub-screen 503 is refreshed includes recommendation items of Snail and Small Shell. The mobile phone 200 receives an S-shaped gesture entered by the user on HiBoard shown in FIG. 5(a). In response to the S-shaped gesture, the mobile phone 200 may refresh display content on all sub-screens in HiBoard, and display corresponding second display content on all the sub-screens. The second display content is content displayed after the sub-screen is refreshed. For example, referring to FIG. 5(b), second display content displayed on an “application suggestion” sub-screen 504 after the refresh includes application icons of Alipay, Stocks, Taobao, and BOC, second display content displayed on a “video recommendation” sub-screen 505 after the refresh includes recommendation items of My Little Pony and Happy Childhood, and second display content displayed on a “music recommendation” sub-screen 506 after the refresh includes recommendation items of Fairy Tale and ABC Song.

It should be noted that the first operation is used to refresh the display content on all the sub-screens such as the “application suggestion” sub-screen 501, the “video recommendation” sub-screen 502, and the “music recommendation” sub-screen 503 in HiBoard shown in FIG. 5(a). It can be learned by comparing FIG. 5(a) with FIG. 5(b) that the mobile phone 200 refreshes, in response to the S-shaped gesture, the display content on all the sub-screens (including the “application suggestion” sub-screen 501, the “video recommendation” sub-screen 502, and the “music recommendation” sub-screen 503) in HiBoard.

### Implementation (3)

The first operation may be an operation performed by the user on the first screen. The first operation is used to refresh display content on a selected sub-screen (for example, the first sub-screen) in the first screen. In the implementation (3), in response to the first operation, the terminal needs to refresh only the display content on the selected first sub-screen, but does not need to refresh display content on another sub-screen in the first screen.

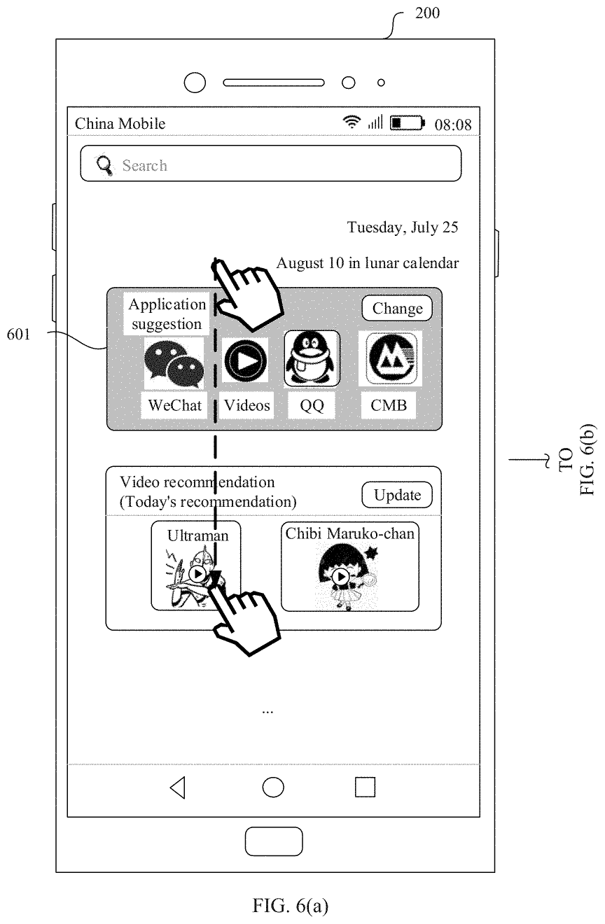

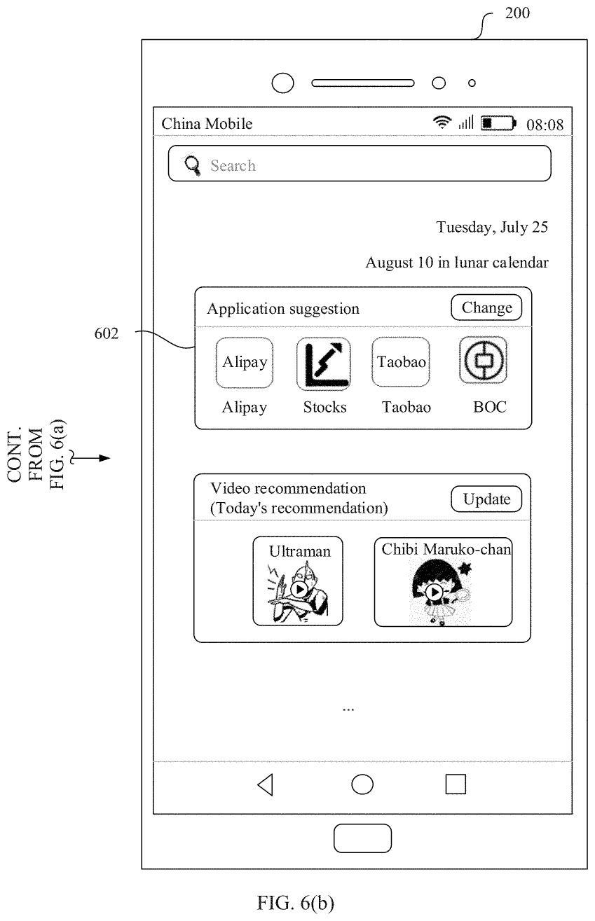

For example, in the application scenario (1), it is assumed that the first operation is a first preset gesture such as a top-down pull-down gesture entered by the user on HiBoard. On HiBoard of the mobile phone shown in FIG. 6(a), the user selects an “application suggestion” sub-screen 601 by performing a tap operation, a double-tap operation, or a touch and hold operation.

In FIG. 6(a), a gray part is used to represent the first sub-screen selected by the user. For display content displayed before each sub-screen in HiBoard of the mobile phone shown in FIG. 6(a) is refreshed, refer to the description of HiBoard of the mobile phone shown in FIG. 5(a). Details are not described herein again in this embodiment of this application.

The mobile phone 200 receives a top-down pull-down gesture entered by the user on HiBoard shown in FIG. 6(a). In response to the top-down pull-down gesture, the mobile phone 200 may refresh display content on the first sub-screen that is in HiBoard and that is selected by the user, and display corresponding second display content on the first sub-screen selected by the user. For example, referring to FIG. 6(b), because the first sub-screen selected by the user is the “application suggestion” sub-screen 601, second display content displayed on an “application suggestion” sub-screen 602 after the refresh includes application icons of Alipay, Stocks, Taobao, and BOC. However, display content on a “video recommendation” sub-screen and display content on a “music recommendation” sub-screen in FIG. 6(a) and FIG. 6(b) do not change.

S304: The terminal receives a second operation performed by the user on the second display content. The second operation is an operation of viewing the display content displayed before the update.

S305: The terminal displays the first display content on the first screen based on the first display record in response to the second operation.

The second operation is the operation of viewing the display content displayed before the update. To be specific, the second operation is used to instruct the terminal to display, on the first sub-screen in the first screen, historical display content displayed before update, The historical display content includes content displayed on the first sub-screen before the display content on the first sub-screen is refreshed. For example, the historical display content includes the first display content.

In some embodiments, the second operation may be a second preset gesture performed by the user on the first display content. The second preset gesture may be used to instruct the terminal to display the historical display content on the first sub-screen. For example, the second preset gesture may be any gesture such as a top-down slide gesture, a left-to-right slide gesture, a bottom-up slide gesture, a circular gesture (a circle-similar gesture), a semi-circular gesture, or an S-shaped gesture. The second operation is different from the first operation. In other words, the second preset gesture is different from the first preset gesture. For example, when the first preset gesture is a top-down slide gesture, the second preset gesture is a bottom-up slide gesture. When the first preset gesture is a left-to-right slide gesture, the second preset gesture is a right-to-left slide gesture.

In some other embodiments, the first sub-screen may include a return key, or a return option. The return key, the return key, or the return option is used to control the terminal to display the display content displayed before the first sub-screen is refreshed. For example, the return key, the return key, or the return option may be “Return”, “Before Refresh”, “Withdraw”, or the like. This is not limited in this embodiment of this application. For example, the first sub-screen includes the return key. The second operation performed by the user on the first sub-screen on which the second display content is displayed may be an operation performed by the user on the return key. For example, the second operation may be any operation such as a tap operation, a double-tap operation, or a touch and hold operation performed by the user on the return key.

For example, in the application scenario (1), it is assumed that the first operation is a first preset gesture entered by the user on the first sub-screen on which the first display content is displayed. For example, the first operation is a top-down slide gesture. The second operation is a second preset gesture entered by the user on the first sub-screen on which the second display content is displayed. For example, the second operation is a bottom-up slide gesture.

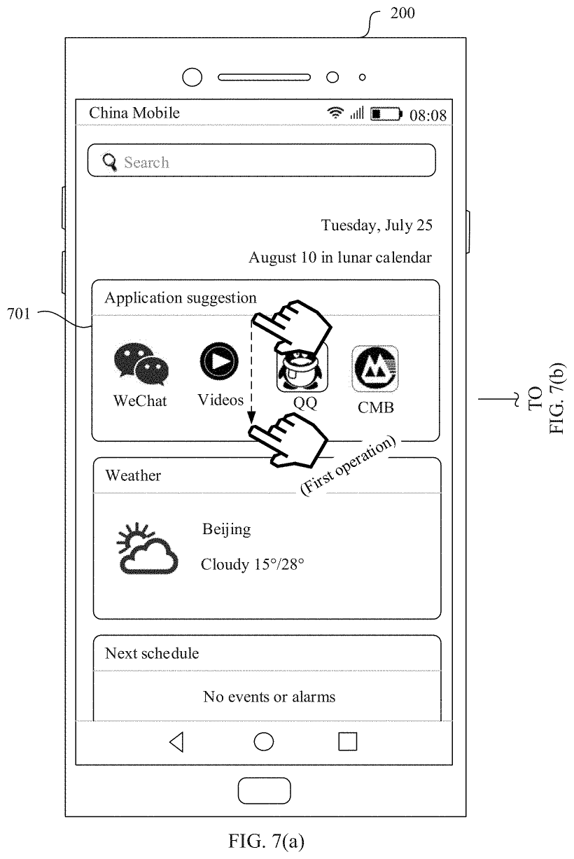

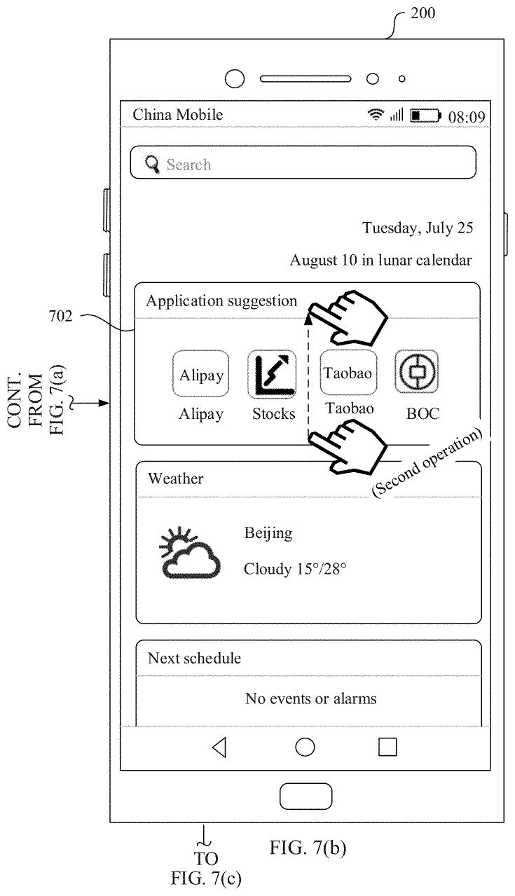

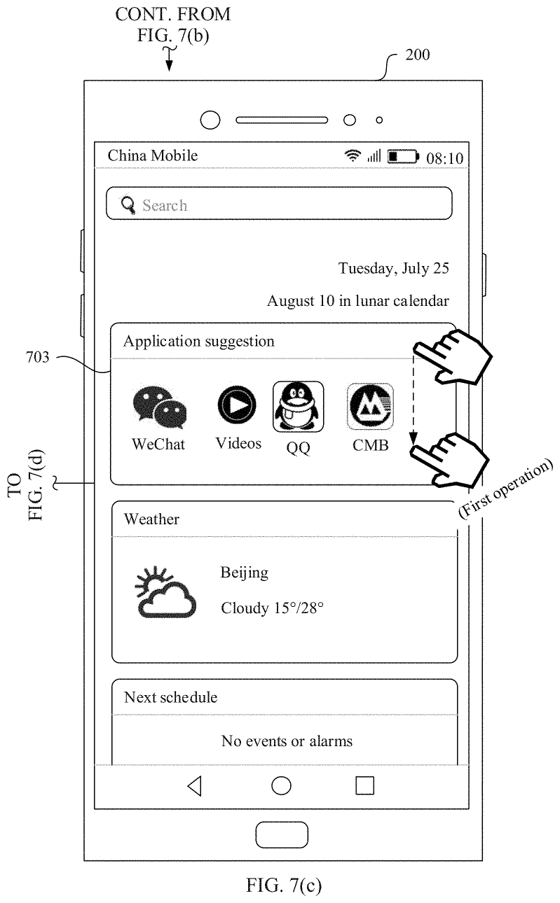

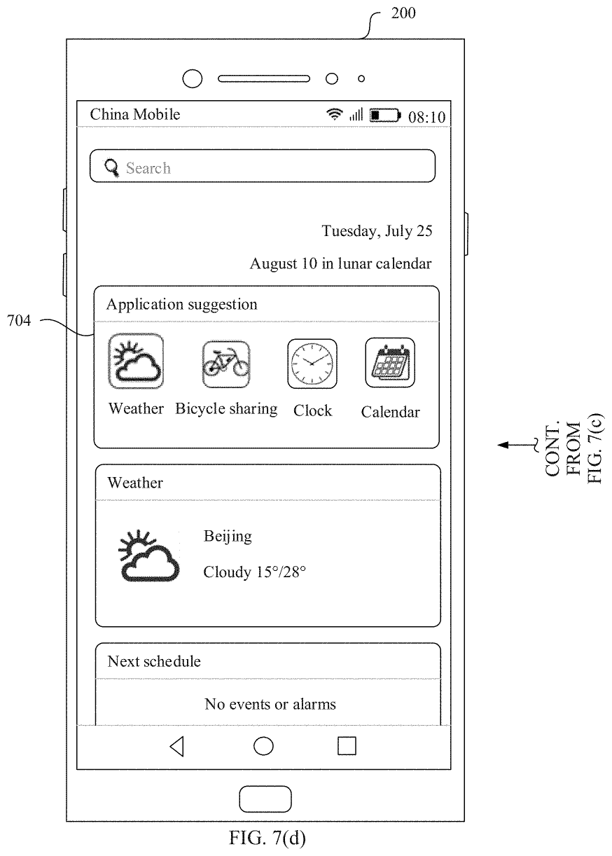

On HiBoard of the mobile phone shown in FIG. 7(a), first display content displayed before an “application suggestion” sub-screen 701 is refreshed includes application icons of WeChat, Videos, QQ, and CMB. In response to a top-down slide gesture entered by the user on the “application suggestion” sub-screen 701 shown in FIG. 7(a), the mobile phone 200 may refresh the first display content displayed on the “application suggestion” sub-screen 701, and display second display content on an “application suggestion” sub-screen 702 shown in FIG. 7(b). The second display content displayed on the “application suggestion” sub-screen 702 includes application icons of Alipay, Stocks, Taobao, and BOC. The mobile phone 200 may redisplay the first display content on an “application suggestion” sub-screen 703 in response to a bottom-up slide gesture entered by the user on the “application suggestion” sub-screen 702 shown in FIG. 7(b).

It should be emphasized that in this embodiment of this application, the first operation and the second operation are not page flipping operations performed on the display content on the first sub-screen. The first operation is different from a tap operation performed on a “next page” key (a “next page” key or the like) on the first sub-screen in a conventional solution. In addition, a case in which the terminal performs an event indicated by the first operation is also different from a case in which the terminal performs an event indicated by tapping the “next page” key in the conventional solution. The second operation is different from a tap operation performed on a “previous page” key (a “previous page” key or the like) on the first sub-screen. In addition, a case in which the terminal performs an event indicated by the second operation is also different from a case in which the terminal performs an event indicated by tapping the “previous page” key in the conventional solution.

In the conventional solution, the terminal may display, in response to a tap operation performed by the user on the “previous page” key (or the “previous page” key) on the sub-screen, display content different from current content on the sub-screen. However, because the terminal cannot display, on the sub-screen due to a limited area of the sub-screen, all of a plurality of pieces of display content that have been obtained and stored in the terminal, the terminal may display different display content on the sub-screen in response to the tap operation performed by the user on the “previous page” key. Therefore, the terminal displays, on the sub-screen in pages, the plurality of pieces of display content that have been obtained and stored in the terminal.

In an example of the “video recommendation” sub-screen 402 shown in FIG. 4(a), it is assumed that videos recommended by the mobile phone 200 to the user on the “video recommendation” sub-screen 402 include “Ultraman”, “Chibi Maruko-chan”, “Peppa Pig”, and “Qiqi Panda”. The mobile phone 200 has obtained recommendation information of “Ultraman”, “Chibi Maruko-chan”, “Peppa Pig”, and “Qiqi Panda” and stored the recommendation information in the terminal. A limited area of the “video recommendation” sub-screen 402 is insufficient to display all of the recommendation items (namely, the first display content) of “Ultraman”, “Chibi Maruko-chan”, “Peppa Pig”, and “Qiqi Panda”. Therefore, the mobile phone 200 may display the recommendation items of the four videos in two pages. As shown in FIG. 4(a), the mobile phone 200 displays recommendation items of “Ultraman” and “Chibi Maruko-chan” on the “video recommendation” sub-screen 402 in HiBoard. The mobile phone 200 may display, in response to a tap operation performed by the user on the “previous page” key on the “video recommendation” sub-screen 402 shown in FIG. 4(a), the “video recommendation” sub-screen 404 shown in FIG. 4(b). The “video recommendation” sub-screen 404 shown in FIG. 4(b) includes recommendation items of “Peppa Pig” and “Qiqi Panda”.

However, in this embodiment of this application, that the terminal updates the displayed first display content on the first sub-screen in response to the first operation means that the terminal re-obtains and displays new display content, instead of displaying, on the first sub-screen, the display content that needs to be displayed in pages due to the limited area of the sub-screen. For example, when receiving a tap operation performed by the user on the “update” key shown in FIG. 4(b), the mobile phone 200 may update the display content on the “video recommendation” sub-screen 404 and display recommendation items different from those of “Ultraman”, “Chibi Maruko-chan”, “Peppa Pig”, and “Qiqi Panda” on the “video recommendation” sub-screen 405 shown in FIG. 4(c). It is assumed that the mobile phone 200 learns, in response to the tap operation performed by the user on the “update” key shown in FIG. 4(b), that updated display content is recommendation items (namely, the second display content) of “My Little Pony”, “Happy Childhood”, “Rise of the Planet of the Apes”, and “A Christmas Carol”. For example, as shown in FIG. 4(c), recommendation items of “My Little Pony” and “Happy Childhood” are displayed on the “video recommendation” sub-screen 405. Referring to the conventional solution, the mobile phone 200 may display, in response to a tap operation performed by the user on the “next page” key shown in FIG. 4(c), the “video recommendation” sub-screen 406 shown in FIG. 4(d). The “video recommendation” sub-screen 406 includes recommendation items of “Rise of the Planet of the Apes” and “A Christmas Carol”.

It should be noted that the terminal displays, in response to a tap operation performed by the user on the “next page” key, display content existing after page flipping. Subsequently, the terminal may further redisplay, in response to a tap operation performed by the user on the “previous page” key, display content existing before page flipping. However, in the conventional solution, after the terminal refreshes the display content on the sub-screen in response to the tap operation performed by the user on the “update” key, the terminal cannot redisplay, on the sub-screen, the display content displayed before the refresh. For example, the mobile phone 200 displays, in response to a tap operation performed by the user on the “update” key shown in FIG. 4(b), the “video recommendation” sub-screen 405 shown in FIG. 4(c). In this case, the user cannot control the mobile phone 200 to redisplay the “video recommendation” sub-screen 402 shown in FIG. 4(a) or the “video recommendation” sub-screen 404 shown in FIG. 4(b). According to the display control method provided in this embodiment of this application, the terminal may display, on the sub-screen of the terminal, historical content displayed before the sub-screen is refreshed. In this way, intelligence of the terminal can be improved, and efficient interaction between the terminal and the user can be implemented.

An embodiment of this application provides a display control method. A terminal may display a first screen including first display content. The terminal may receive a first operation performed by a user on the first display content. The terminal stores a first display record corresponding to the first display content, and updates the first display content displayed on a first sub-screen to second display content, in response to the first operation. The terminal receives a second operation performed by the user on the first sub-screen on which the second display content is displayed. The terminal redisplays the first display content based on the first display record in response to the second operation. In other words, according to the method in this embodiment of this application, the terminal can display, on a sub-screen of the terminal, historical content displayed before the sub-screen is refreshed. In this way, intelligence of the terminal can be improved, and efficient interaction between the terminal and the user can be implemented.

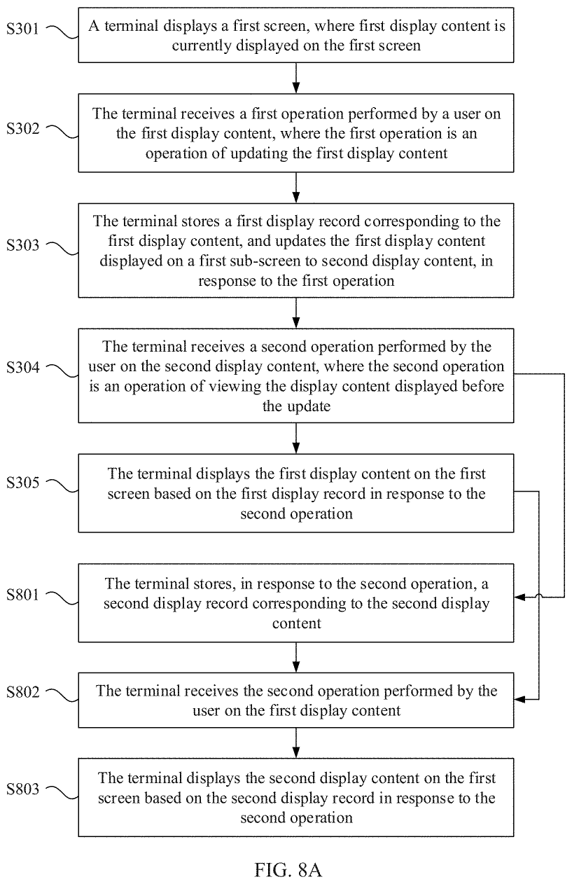

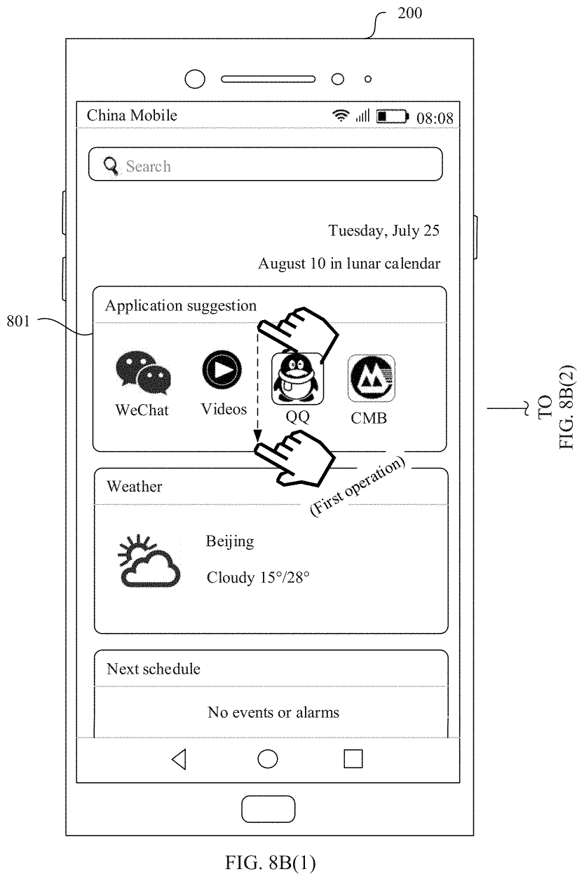

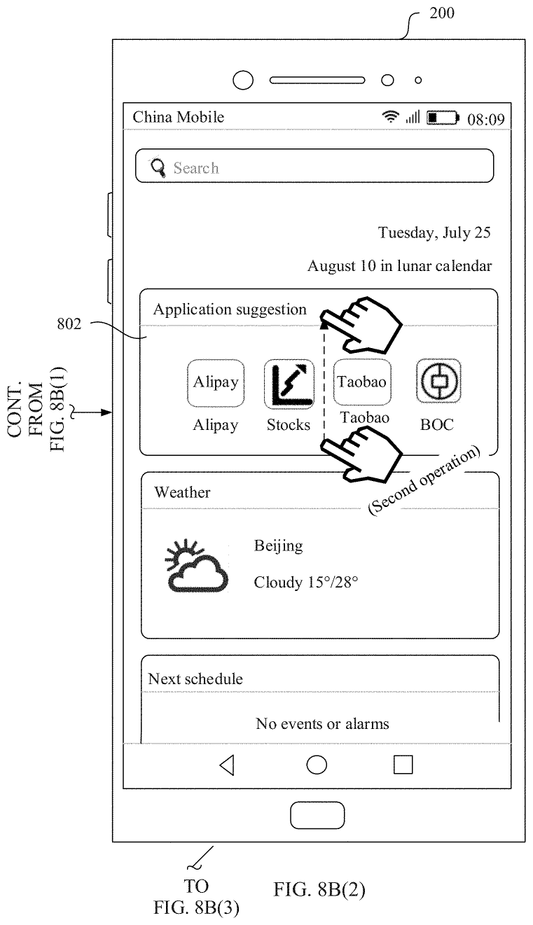

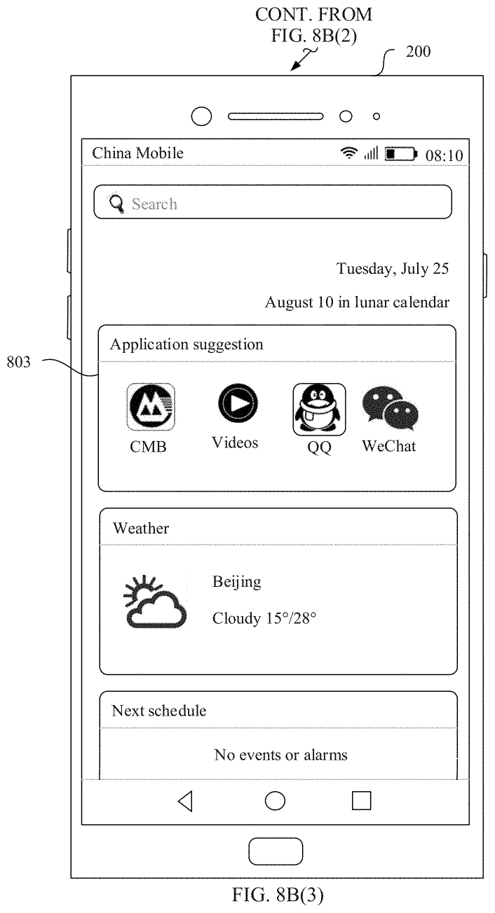

It may be understood that to enable the terminal to redisplay the first display content on the first sub-screen in response to the second operation after the display content on the first sub-screen is refreshed, and to enable the terminal to further display the second display content after the terminal redisplays the first display content, as shown in FIG. 8A, after S304, the method in this embodiment of this application may further include S801.

S801: The terminal stores, in response to the second operation, a second display record corresponding to the second display content.

After S305 (the terminal redisplays the first display content), the terminal may further receive the second operation performed by the user on the redisplayed first display content to display the second display content. As shown in FIG. 8A, after S801 and S305, the method in this embodiment of this application may further include S802 and S803.

S802: The terminal receives the second operation performed by the user on the first display content.

S803: The terminal displays the second display content on the first screen based on the second display record in response to the second operation.

In this embodiment of this application, the second display record includes the second display content or an identifier of the second display content. Alternatively, the second display record includes the second display content or an identifier of the second display content, and layout information of the second display content on the first screen.

In this embodiment of this application, the display record in this embodiment of this application is described herein by using the first display record as an example.

In an implementation, the first display record may be the first display content. In other words, the first display record stored in the terminal is the first display content displayed by the terminal on the first sub-screen. For example, when the first display content includes a plurality of application icons, the first display record may be the plurality of application icons. When the first display content includes a plurality of pictures recommended by the terminal to the user, the first display record may be the plurality of pictures. The terminal may directly display, on the first sub-screen in response to the second operation, the first display record (namely, the first display content) stored in the terminal.

In another implementation, the first display record may be the identifier of the first display content. In this embodiment of this application, the identifier of the first display content may be address information or index information of the first display content stored in the terminal. For example, when the first display content includes a plurality of pictures recommended by the terminal to the user, the first display record may include the identifier of the first display content. The identifier of the first display content may be address information or index information of the plurality of pictures stored in the terminal. In response to the second operation, the terminal may obtain the plurality of pictures based on the address information or the index information in the first display record, and display the plurality of pictures on the first sub-screen.

When the first display content includes recommendation items of a plurality of objects in a second application, the first display record may include the identifier of the first display content. The identifier of the first display content may be identifiers of the plurality of objects in the second application. The second application may be a video application, a music application, a shopping application, a travel application, or the like. For example, when the second application is the video application, the plurality of objects may be a plurality of videos provided by the video application. The video application may be iQIYI, Youku, Tencent Video, or the like. When the second application is the music application, the plurality of objects may be a plurality of songs provided by the music application. The music application may be QQ Music, Baidu Music, NetEase Cloud Music, or the like. When the second application is the shopping application, the plurality of objects may be a plurality of commodities provided by the shopping application. The shopping application may be Taobao, JD, or the like. When the second application is the travel application, the plurality of objects may be a plurality of travel items provided by the travel application.

For example, the second application is the video application. Assuming that the first display content displayed by the terminal on the first sub-screen includes recommendation items of a video 1, a video 2, and a video 3, the first display record may include identifiers of the video 1, the video 2, and the video 3. In this case, the identifiers of the plurality of objects may be names of the plurality of objects. Alternatively, the identifiers of the plurality of objects may be link information of the plurality of objects. The terminal may find an object from the second application based on a name or link information of the object.

In another implementation, the first display record may include the first display content or the identifier of the second display content. The first display record may further include layout information of the first display content on the first screen (namely, the first sub-screen). In this implementation, in response to the second operation, the terminal may first obtain the first display content corresponding to the first display record, then typeset the obtained first display content based on the layout information included in the first display record, and finally, display the typeset first display content on the first sub-screen.

It should be noted that the layout information is optional. The first display record may not include the layout information. In this case, although the terminal may redisplay the first display content in response to the second operation, a layout of the first display content on the first sub-screen may change. For example, on the first sub-screen, a layout of the redisplayed first display content may be different from a layout of the first display content displayed for the first time.

For example, on HiBoard of the mobile phone shown in FIG. 8B(1)), first display content displayed before an “application suggestion” sub-screen 801 is refreshed includes application icons of WeChat, Videos, QQ, and CMB. In response to a top-down slide gesture entered by the user on the “application suggestion” sub-screen 801 shown in FIG. 8B(1), the mobile phone 200 may refresh first display content displayed on the “application suggestion” sub-screen 801, and display second display content on an “application suggestion” sub-screen 802 shown in FIG. 8B(2). The second display content displayed on the “application suggestion” sub-screen 702 includes application icons of Alipay, Stocks, Taobao, and BOC. The mobile phone 200 may redisplay the first display content on an “application suggestion” sub-screen 803 in response to a bottom-up slide gesture entered by the user on the “application suggestion” sub-screen 802 shown in FIG. 8B(2). However, it can be learned by comparing the “application suggestion” sub-screen 801 shown in FIG. 8B(1) with the “application suggestion” sub-screen 803 shown in FIG. 8B(3) that although the “application suggestion” sub-screen 801 and the “application suggestion” sub-screen 803 each include the first display content, that is, the application icons of WeChat, Videos, QQ, and CMB, the application icons of WeChat, Videos, QQ, and CMB have different layouts on the “application suggestion” sub-screen 801 and the “application suggestion” sub-screen 803.

In some embodiments, the terminal may store a plurality of display records on the first sub-screen (for example, in a preset record set), for example, the first display record and the second display record. The preset record set may store the display records in a time sequence. S305 may specifically include: The terminal obtains the first display record latest stored in the preset record set from the preset record set, determines the first display content based on the first display record, and displays the first display content on the first sub-screen, in response to the second operation. When the first display record is the first display content, the terminal may directly store the first display content in the preset record set. When the first display record is the identifier of the first display content, the terminal may store the first display content, and store the identifier of the first display content in the preset record set. In this way, based on the identifier that is of the first display content and that is stored in the preset record set, the terminal may obtain the first display content, and display the first display content on the first sub-screen.

It should be noted that in this embodiment of this application, the terminal may maintain a preset record set for each sub-screen in each application.

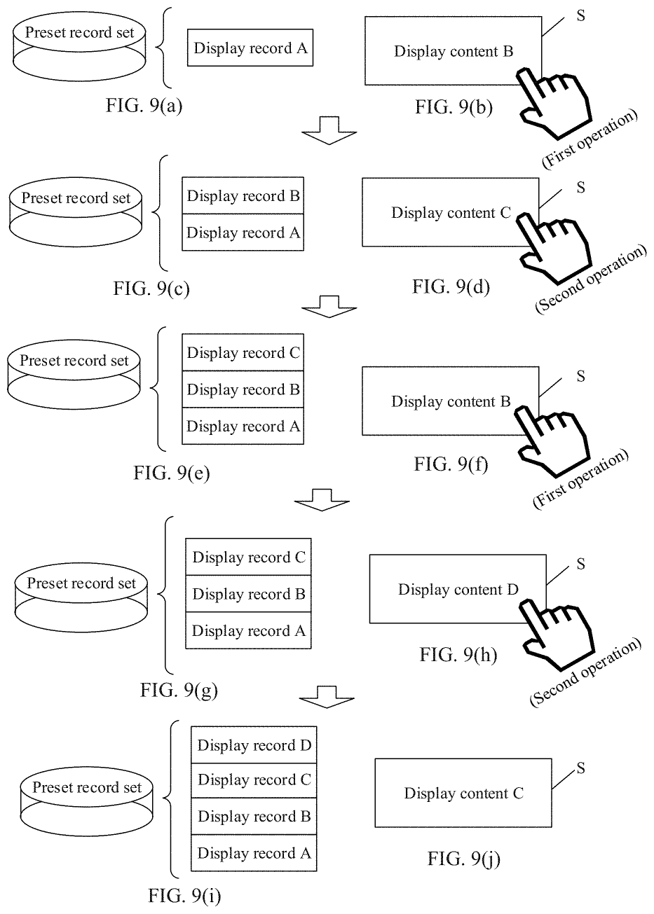

In this embodiment of this application, the display control method provided in this embodiment of this application is described herein by using an example in which a sub-screen S shown in FIG. 9(a) to FIG. 9(j) is the first sub-screen displayed by the terminal.

As shown in FIG. 9(b), it is assumed that display content B is currently displayed on the sub-screen S. To be specific, the display content B shown in FIG. 9(b) is first display content. A preset record set shown in FIG. 9(a) stores a display record A. The display record A corresponds to display content A. The terminal updates, in response to a refresh operation (a first operation) performed by the user on the sub-screen S shown in FIG. 9(b), the display content B displayed on the sub-screen S to display content C shown in FIG. 9(d). The display content C shown in FIG. 9(d) is second display content. In addition, as shown in FIG. 9(c), the terminal may store, in response to the first operation, a display record B of the display content B in the preset record set shown in FIG. 9(a). The display record B corresponds to the display content B.

It is assumed that a second operation is used to instruct the terminal to display display content displayed before the sub-screen S is latest refreshed. For example, as shown in FIG. 9(b), display content on the sub-screen is C after the latest refresh. As shown in FIG. 9(d), display content on the sub-screen is B before the latest refresh. In this case, the terminal may display, on the sub-screen S in response to a second operation performed by the user on the sub-screen S shown in FIG. 9(d), the display content B (namely, the first display content) shown in FIG. 9(f). In addition, as shown in FIG. 9(e), the terminal may store, in response to the second operation, a display record C of the display content C in a preset record set shown in FIG. 9(c). The display record C corresponds to the display content C.

Correspondingly, if the terminal receives a second operation performed by the user on the sub-screen S shown in FIG. 9(f), the terminal may display the display content A (not shown in FIG. 9) on the sub-screen S. It may be understood that a preset record set shown in FIG. 9(d) has stored the display record B corresponding to the current display content B. Therefore, the terminal does not store, in response to the second operation performed by the user on the sub-screen S shown in FIG. 9(f), the display record B (not shown in FIG. 9(a) to FIG. 9(j)) in the preset record set.

In some embodiments, after performing S305 of redisplaying the first display content on the first sub-screen, the terminal may receive the first operation (a refresh operation) performed by the user on the first sub-screen on which the first display content is displayed. In this case, the terminal may update, in response to the first operation, the first display content displayed on the first sub-screen to third display content.

For example, the terminal receives a first operation performed by the user on the sub-screen S shown in FIG. 9(f). The terminal may update, in response to the first operation, the display content B displayed on the sub-screen S to display content D. In other words, the terminal displays, on the sub-screen S, the display content D shown in FIG. 9(h). It may be understood that a preset record set shown in FIG. 9(e) has stored the display record C corresponding to the current display content C. Therefore, the terminal does not store the display record C in the preset record set in response to the first operation performed by the user on the sub-screen S shown in FIG. 9(f). To be specific, the preset record set shown in FIG. 9(e) does not change compared with a preset record set shown in FIG. 9(g).

The terminal may display, on the sub-screen S in response to a second operation performed by the user on the display content D shown in FIG. 9(h), the display content C shown in FIG. 9(j). In addition, in response to the second operation, the terminal may store a display record D of the display content D in the preset record set shown in FIG. 9(g), to obtain a preset record set shown in FIG. 9(i). Compared with the preset record set shown in FIG. 9(g), a new display record D is added to the preset record set shown in FIG. 9(i).

In some embodiments, the preset record set may be a preset stack. That the terminal stores, in response to the first operation, a first display record corresponding to the first display content may specifically include: The terminal pushes the first display record onto the preset stack in response to the first operation. A stack pointer of the preset stack points to a display record on a stack top of the preset stack in response to the first operation. In this embodiment of this application, S305 may include: The terminal obtains the first display record to which the stack pointer points, determines the first display content based on the first display record, and displays the first display content on the first sub-screen, in response to the second operation. In addition, the terminal may push the second display record onto the preset stack.

In other words, the terminal may display, in response to the second operation, display content corresponding to the display record to which the stack pointer points. It may be understood that the stack stores, in a first-in last-out manner, information pushed onto the stack. For example, the preset stack stores, in a first-in last-out manner, the display record pushed onto the preset stack. In addition, when a new display record is pushed onto the preset stack, the stack pointer of the preset stack points to the newly pushed display record. For example, the terminal pushes the first display record onto the preset stack in response to the first operation. In this case, the first display record is located on the stack top of the preset stack, and the stack pointer currently indicates the first display record located on the stack top. Then, in response to the second operation, the terminal may display the first display content corresponding to the first display record that is located on the stack top and to which the stack pointer points, and push the second display record onto the preset stack. After the terminal pushes the second display record onto the stack, the stack pointer points to the second display record located on the stack top.

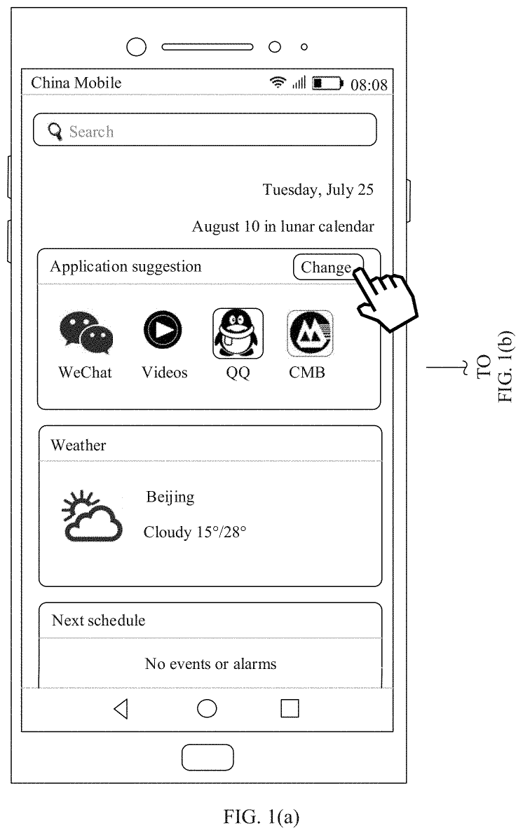

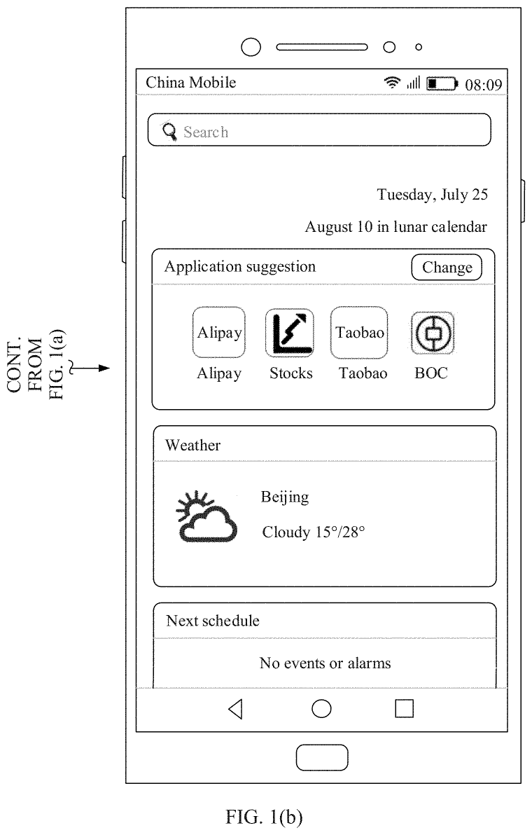

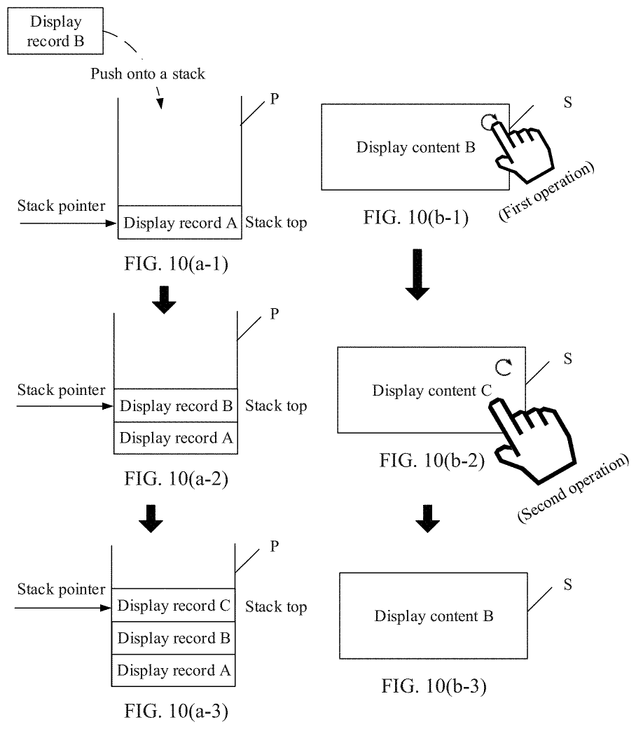

In this embodiment of this application, an example in which a sub-screen S shown in FIG. 10(a-1) to FIG. 10(a-3) and FIG. 10(b-1) to FIG. 10(b-3) is the first sub-screen displayed by the terminal is used herein to describe a specific process of implementing, by using a preset stack, the display control method provided in this embodiment of this application.

As shown in FIG. 10(b-1), it is assumed that display content B is currently displayed on the sub-screen S. To be specific, the display content B shown in FIG. 10(b-1) is first display content. A display record A is pushed onto a preset stack P shown in FIG. 10(a-1). The display record A corresponds to display content A. The terminal receives a first operation (for example, a tap operation performed by the user on a refresh key on the sub-screen S) performed by the user on the display content B shown in FIG. 10(b-1). In response to the first operation, the terminal may push a display record B onto the preset stack P shown in FIG. 10(a-1), to obtain a preset stack P shown in FIG. 10(a-2). The display record B corresponds to the display content B. In the preset stack P shown in FIG. 10(a-2), a stack pointer points to the display record B on a stack top. The terminal may update, in response to the first operation, the display content B displayed on the sub-screen S to display content C shown in FIG. 10(b-2).

In this embodiment of this application, when a second operation is a different user operation, the second operation is used to instruct the terminal to display different historical display content.

In one case, the second operation may be used to instruct the terminal to display display content displayed before the sub-screen S is latest refreshed. For example, when the second operation is a double-tap operation (for example, a double-tap operation performed on the sub-screen S) performed by the user on second display content, the second operation may be used to instruct the terminal to display the display content displayed before the sub-screen S is latest refreshed.

For example, as shown in FIG. 10(b-2), display content on the sub-screen is C after the latest refresh. As shown in FIG. 10(b-1), display content on the sub-screen is B before the latest refresh. To be specific, the second operation corresponds to the display content B. In this case, in response to the second operation performed by the user on the sub-screen S shown in FIG. 10(b-2), because the stack pointer of the preset stack P shown in FIG. 10(a-2) points to the display record B, as shown in FIG. 10(b-3), the terminal may redisplay, on the sub-screen S, the display content B to which the stack pointer shown in FIG. 10(a-2) points. In addition, in response to the second operation, the terminal may push a display record C onto the preset stack P shown in FIG. 10(a-2), to obtain a preset stack P shown in FIG. 10(a-3).

In the other case, the second operation may be used to instruct the terminal to display display content displayed before the sub-screen S is refreshed for the (N-n)^{th} time. Herein, n is a natural number greater than or equal to 1. The N^{th} time that the sub-screen S is refreshed is the last time that the sub-screen S is refreshed. N is a natural number greater than n. For example, when the second operation is a touch and hold operation performed by the user on the sub-screen S, the second operation may be used to instruct the terminal to display the display content displayed before the sub-screen S is refreshed for the (N-n)^{th} time.

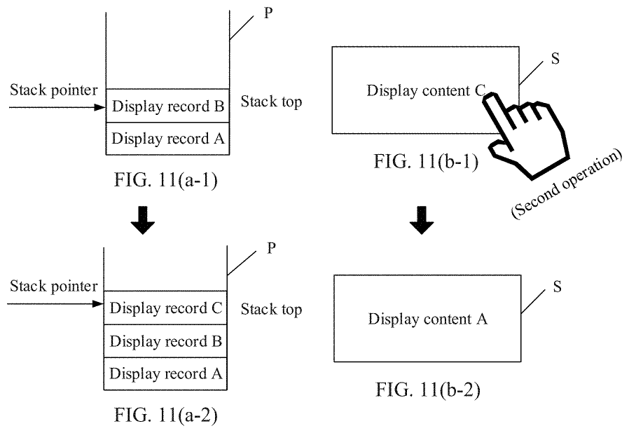

For example, with reference to FIG. 10(a-1) to FIG. 10(a-3) and FIG. 10(b-1) to FIG. 10(b-3) and FIG. 11(a-1) and FIG. 11(a-2) and FIG. 11(b-1) and FIG. 11(b-2), it is assumed that N=2 and n=1. As shown in FIG. 11(a-1), display content on the sub-screen is C after the latest refresh (namely, the second refresh). As shown in FIG. 11(a-1), display content on the sub-screen is A before previous refresh (namely, the first refresh) of the latest refresh. To be specific, the second operation corresponds to the display content A. In this case, in response to the second operation performed by the user on the sub-screen S shown in FIG. 11(b-1), the terminal may push a display record C onto the preset stack P shown in FIG. 11(a-1), to obtain a preset stack P shown in FIG. 11(a-2). In addition, as shown in FIG. 11(b-2), the terminal may redisplay the display content A on the sub-screen S in response to the second operation.

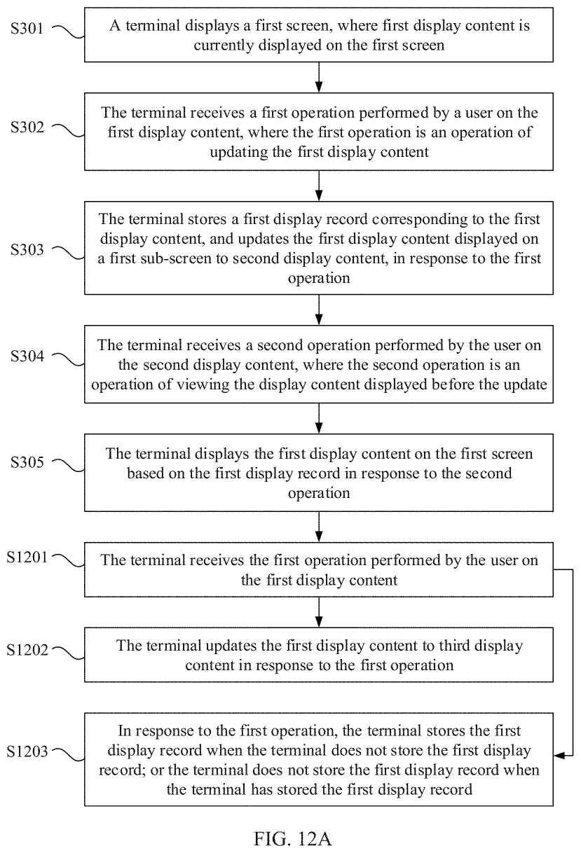

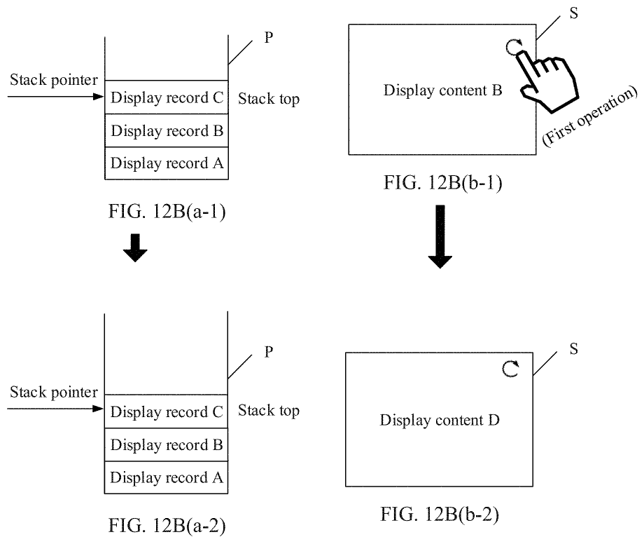

In some embodiments, after performing S305 of redisplaying the first display content on the first screen (for example, the first sub-screen in the first screen), the terminal may receive the first operation (a refresh operation) performed by the user on the first sub-screen on which the first display content is displayed. In this case, in response to the first operation, the terminal may update the display content on the first sub-screen, and display third display content on the first sub-screen. The third display content is different from the first display content, and the third display content is different from the second display content. Specifically, as shown in FIG. 12A, after S305 shown in FIG. 3, the method in this embodiment of this application may further include S1201 to S1203.

S1201: The terminal receives the first operation performed by the user on the first display content.

S1202: The terminal updates the first display content to third display content in response to the first operation.

S1203: In response to the first operation, the terminal stores the first display record when the terminal does not store the first display record; or the terminal does not store the first display record when the terminal has stored the first display record.

It can be learned from S303 that the terminal may store, in response to the first operation, a display record (for example, the first display record) corresponding to display content displayed before the first screen (for example, the first sub-screen) is refreshed. However, after S305, if the terminal receives the first operation performed by the user on the first display content, because the terminal performs S303 in which the first display record has been stored, the terminal may not store the first display record in response to the first operation, to prevent the terminal from storing a plurality of first display records. In other words, for a specific manner of S303 in which “the terminal stores, in response to the first operation, the first display record corresponding to the first display content”, refer to S1203.

For example, referring to FIG. 12B(a-1), a display record A, a display record B, and a display record C are sequentially pushed onto a preset stack P. The display record C is on a stack top of the preset stack P. It is assumed that display content B (namely, the first display content) is displayed on a sub-screen S shown in FIG. 12B(b-1). The terminal may update, in response to a first operation performed by the user on the sub-screen S shown in FIG. 12B(b-1), the display content B displayed on the sub-screen to display content D (namely, the third display content). In this case, because the preset stack P shown in FIG. 12B(a-1) has stored the first display record (namely, the display record B), the terminal does not need to re-push the display record B onto the preset stack P. A preset stack P shown in 12B(a-2) does not change compared with the preset stack P shown in 12B(a-1).

Correspondingly, S801 in which “the terminal stores, in response to the second operation, the second display record corresponding to the second display content” may specifically include: The terminal stores the second display record when the terminal does not store the second display record; or the terminal does not store the second display record when the terminal has stored the second display record.

In some embodiments, the second operation may be a slide operation entered by the user on the first sub-screen. As a sliding location of the slide operation changes, the stack pointer of the preset stack switches between the display records in the preset stack. Display content on the first sub-screen changes with switching of the stack pointer.

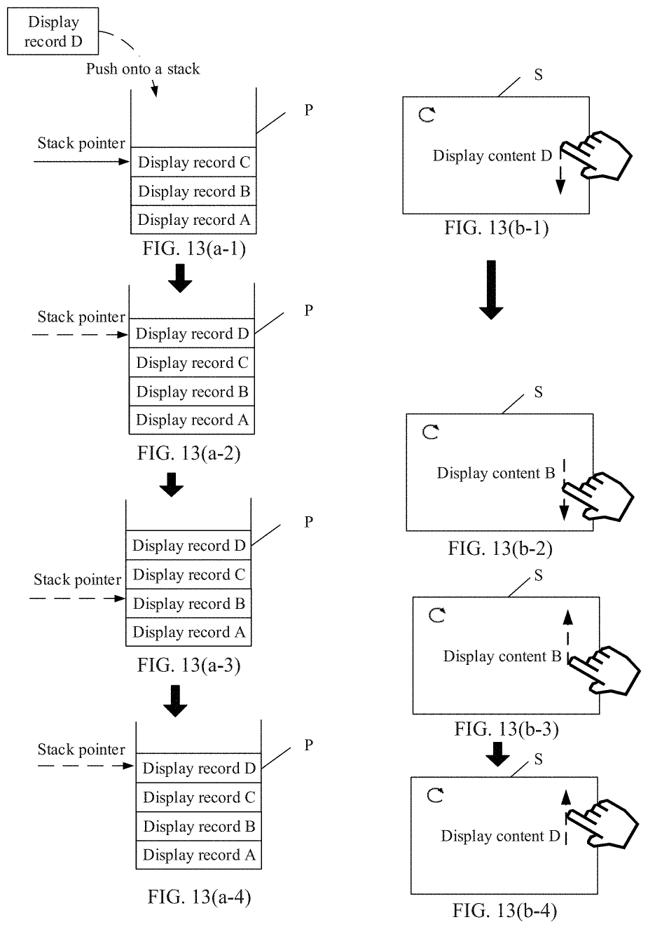

For example, as shown in FIG. 13(a-1), it is assumed that a display record A, a display record B, and a display record C are sequentially pushed onto a preset stack P. A stack pointer shown in FIG. 3(a-1) points to the display record C. Display content D is displayed on a sub-screen S shown in FIG. 13(b-1). The terminal receives a downward slide operation (namely, the second operation) performed by the user on the sub-screen S shown in FIG. 13(b-1). In response to the downward slide operation, the terminal may push a display record D onto the preset stack P shown in FIG. 13(a-1), to obtain a preset stack P shown in FIG. 13(a-2). When a location of a finger of the user on the sub-screen S changes from a location shown in FIG. 13(b-1) to a location shown in FIG. 13(b-2), a display record to which the stack pointer of the preset stack P points is switched from the display record D shown in FIG. 13(a-2) to the display record B shown in FIG. 13(a-3). In other words, display content B is displayed on the sub-screen S shown in FIG. 13(b-2). The terminal receives an upward slide operation performed by the user on the sub-screen S shown in FIG. 13(b-3). When a location of a finger of the user on the sub-screen S changes from a location shown in FIG. 13(b-3) to a location shown in FIG. 13(b-4), a display record to which the stack pointer of the preset stack P points is switched from the display record B shown in FIG. 13(a-3) to the display record D shown in FIG. 13(a-4). In other words, the display content D is displayed on the sub-screen S shown in FIG. 13(b-4).

Optionally, the terminal may further display a navigation bar in response to a slide operation (the second operation) performed by the user on the sub-screen S. The navigation bar may be used to guide the user to operate the terminal. In this way, performance of interaction between the terminal and the user can be improved.

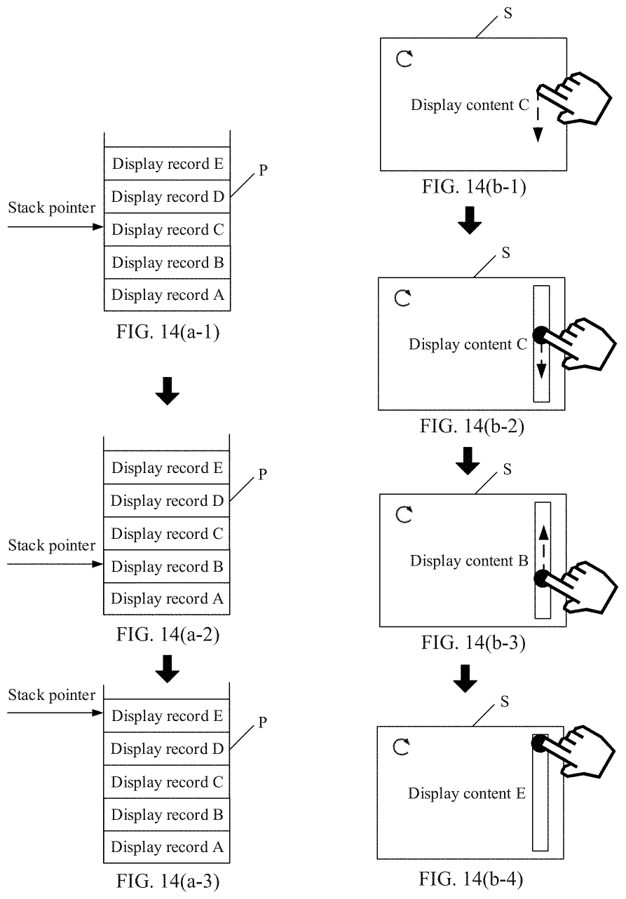

For example, as shown in FIG. 14(a-1), it is assumed that a display record A, a display record B, a display record C, a display record D, and a display record E are sequentially pushed onto a preset stack P. A stack pointer shown in FIG. 14(a-1) points to the display record C. Display content C is displayed on a sub-screen S shown in FIG. 14(b-1).

The terminal receives a downward slide operation (or an upward slide operation) performed by the user on the sub-screen S shown in FIG. 14(b-1). The terminal may display, in response to the slide operation, a navigation bar Q shown in FIG. 14(b-2). The navigation bar Q includes a navigation key. The navigation key is a black dot in FIG. 14(b-2), FIG. 14(b-3), or FIG. 14(b-4). The stack pointer switches between the display records in the preset stack in response to a drag operation performed by the user on the navigation key in the navigation bar Q. For example, when a finger of the user drags the navigation key in the navigation bar Q from a location shown in FIG. 14(b-2) to a location shown in FIG. 14(b-3), the stack pointer of the preset stack P points to display content B shown in FIG. 14(a-2). In other words, display content B is displayed on the sub-screen S shown in FIG. 14(b-3). When the finger of the user drags the navigation key in the navigation bar Q from the location shown in FIG. 14(b-3) to a location shown in FIG. 4(b-4), the stack pointer of the preset stack P points to the display content E shown in FIG. 14(a-3). In other words, display content E is displayed on the sub-screen S shown in FIG. 14(b-4).

In this embodiment of this application, the navigation bar includes but is not limited to the navigation bar shown in FIG. 14(b-2), FIG. 14(b-3), or FIG. 14(b-4). For example, the first sub-screen may further display a horizontal navigation bar. It may be understood that the navigation bar disappears when the terminal detects that the finger of the user leaves a touchscreen of the terminal.

Further, considering that the user may view only historical display content displayed on the first sub-screen in a recent period of time, the terminal may periodically delete a display record stored earlier in a preset record set. Alternatively, when a quantity of display records stored in the preset record set is greater than a preset threshold (for example, K), the terminal may delete the first M display records from the K display records in a storage time sequence. M is less than K, and both M and K are natural numbers greater than 0. Alternatively, the terminal may delete, in response to an operation of disabling a first application by the user, a display record stored in the preset record set.

Because the preset stack stores the display record in a first-in last-out principle, when the preset record set is the preset stack, the terminal may periodically clear (that is, delete) the display record in the preset stack. For example, the terminal may clear the display record in the preset stack at a first preset time every day. The first preset time may be a time at which the terminal learns, by constructing a user profile, that the user does not use the terminal fir a relatively long time. For example, the first preset time may be 0:00, or the first preset time may be any time from 0:00 to 6:00. This is not limited in this embodiment of this application. Alternatively, the terminal may clear (that is, delete) the display record in the preset stack every X days. X is a natural number greater than or equal to 2.

Alternatively, the terminal may delete, in response to an operation of disabling a first application by the user, a display record stored in the preset stack. In this embodiment of this application, that the terminal disables the first application may be as follows: The terminal does not display a screen of the first application on a current screen, but the terminal runs the first application in a background. Alternatively, that the terminal disables the first application may be as follows: The terminal does not display a screen of the first application on a current screen, and the terminal also disables the first application in a background. After the terminal disables the first application in the background, the terminal does not run the first application in the background.

It may be understood that the preset record set in this embodiment of this application includes but is not limited to the foregoing preset stack. For example, the preset record set may alternatively be implemented in a queue manner.

An application scenario of the display control method provided in this embodiment of this application includes but is not limited to the foregoing application scenario (1). The display control method may be further applied to the following plurality of application scenarios:

### Application Scenario (2)

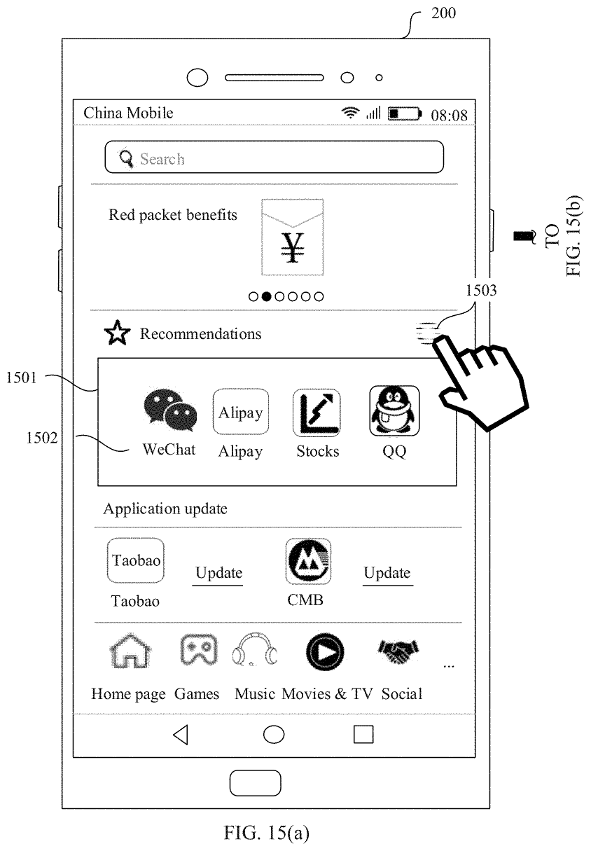

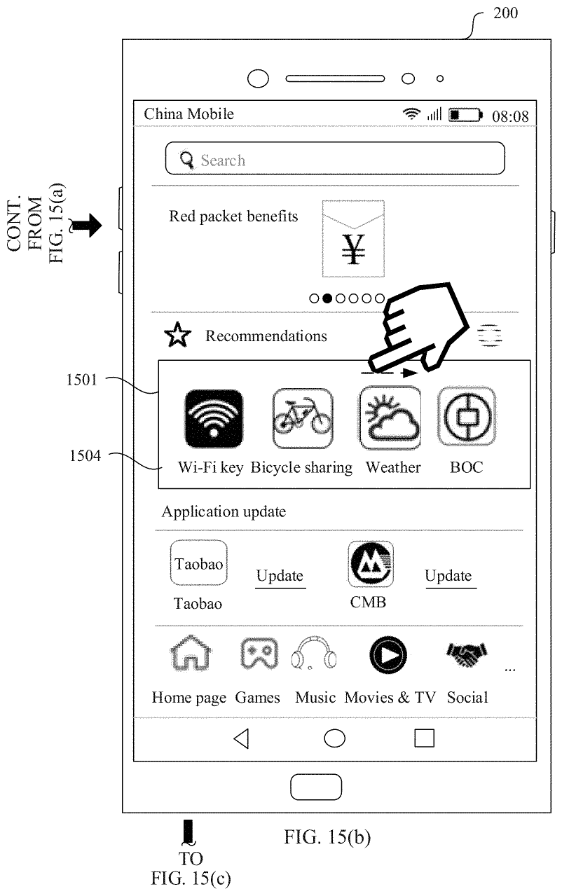

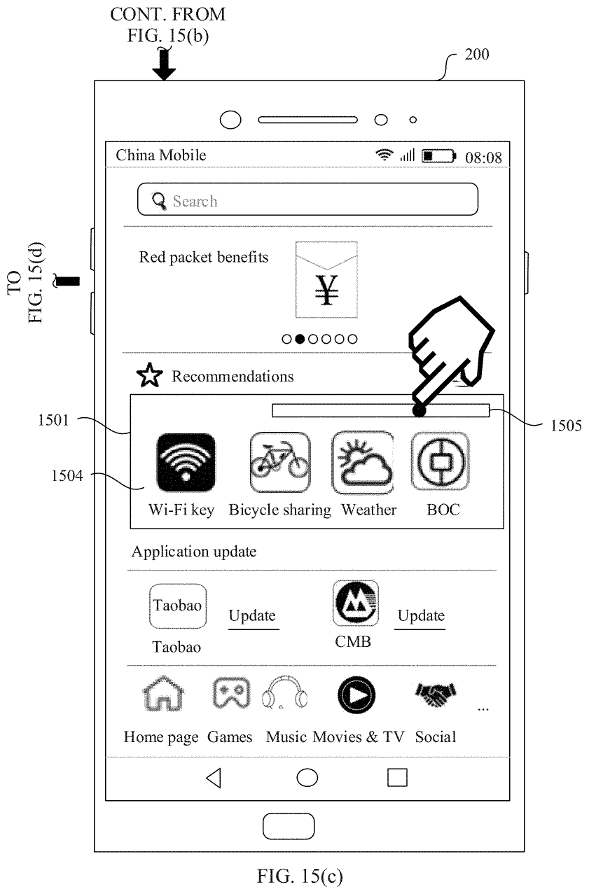

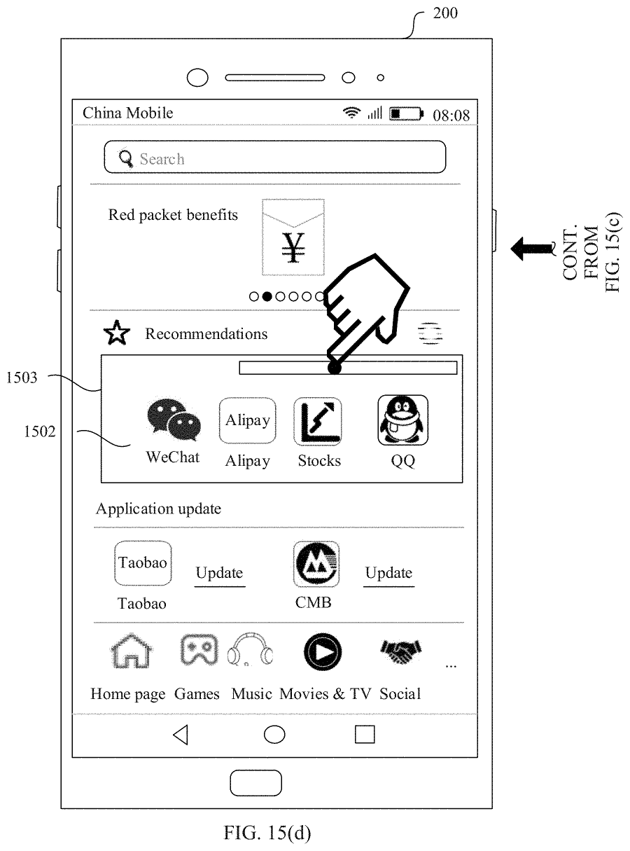

For example, the first application is an application store. The first screen may be a home page of the application store. For example, the first screen is a display screen of an application store of a mobile phone 200 shown in FIG. 15(a). A home page of the application store may include one or more sub-screens. For example, as shown in FIG. 15(a), the home page of the application store includes an “application recommendation” sub-screen 1501. First display content 1502 is displayed on the “application recommendation” sub-screen 1501. The first display content 1502 includes application icons of WeChat, Alipay, Stocks, and QQ. In this application scenario, a first display record is the first display content 1502, and a second display record is second display content 1504.

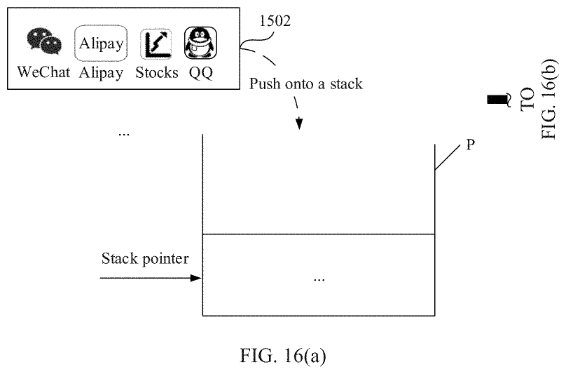

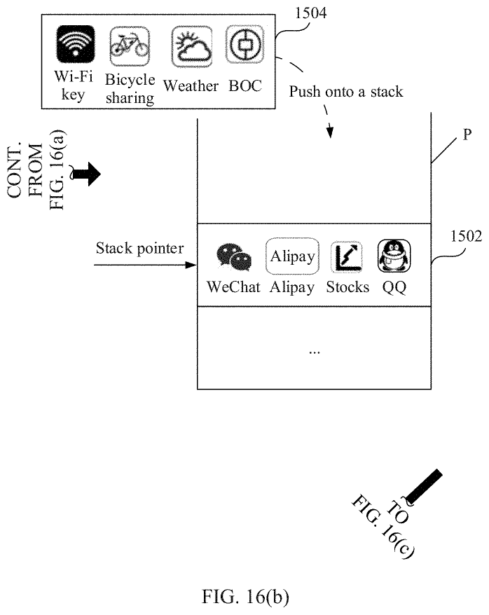

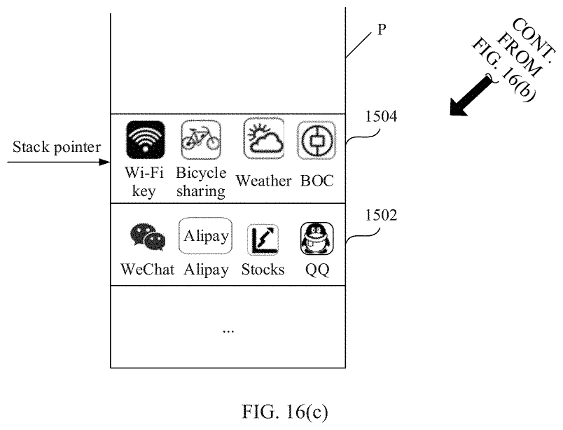

For example, a first operation is a tap operation performed by the user on a refresh key 1503 on the “application recommendation” sub-screen 1501. The mobile phone 200 may refresh the display content on the “application recommendation” sub-screen 1501 in response to the tap operation performed by the user on the refresh key 1503. It is assumed that the refreshed second display content 1504 includes application icons of Wi-Fi key, Bicycle sharing, Weather, and BOC. In response to the first operation, the mobile phone 200 may push the first display content 1502 onto a preset stack P shown in FIG. 16(a), to obtain a preset stack P shown in FIG. 16(b).

For example, a second operation is a left-to-right slide operation performed by the user on the “application recommendation” sub-screen 1501. As shown in FIG. 15(b), when a finger of the user slides on the “application recommendation” sub-screen 1501, the mobile phone 200 may display a navigation bar 1505 on the “application recommendation” sub-screen 1501. The navigation bar 1505 includes a navigation key (a black dot). A stack pointer switches between display records in a preset stack in response to a drag operation performed by the user on the navigation key in the navigation bar 1505. For example, in response to the left-to-right slide operation, when the finger of the user drags the navigation key in the navigation bar 1505 from a location shown in FIG. 15(c) to a location shown in FIG. 15(d), the mobile phone 200 may display the first display content 1502 indicated by the stack pointer of the preset stack P shown in FIG. 16(b). In other words, the mobile phone may redisplay the first display content 1502 on the “application recommendation” sub-screen 1501 shown in FIG. 15(d). In addition, the mobile phone 200 may push the second display content 1504 onto the preset stack P shown in FIG. 16(b), to obtain a preset stack P shown in FIG. 16(c). The navigation bar 1505 disappears when the mobile phone 200 detects that the finger of the user leaves a touchscreen of the mobile phone 200.

In this embodiment of this application, a plurality of types of display content may be displayed on the first sub-screen. In this case, the terminal may store a display record on the first sub-screen in a preset record set (for example, a preset stack). Alternatively, the terminal may separately store, in a plurality of preset record sets (for example, preset stacks), display records of different types of display content displayed on the first sub-screen. The plurality of preset record sets (for example, the preset stacks) are in a one-to-one correspondence with the plurality of types. Each preset record set (for example, a preset stack) stores a display record of one type of display content. For details, refer to detailed descriptions in the following application scenario (3).

### Application Scenario (3)

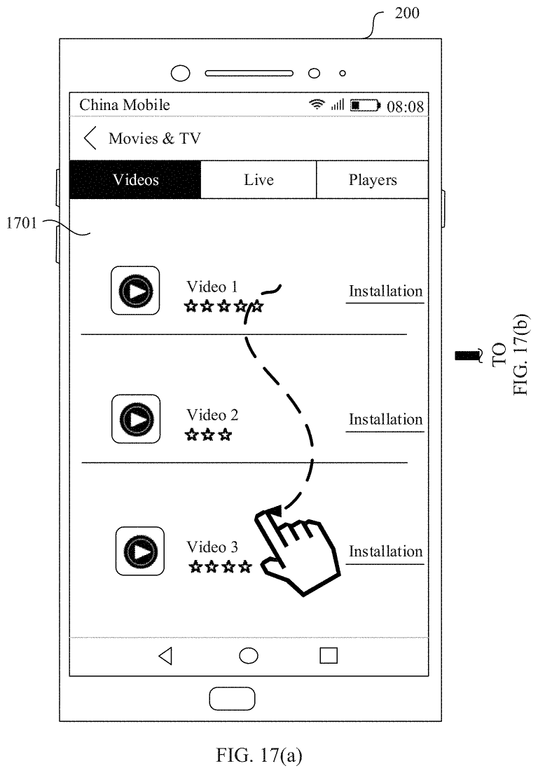

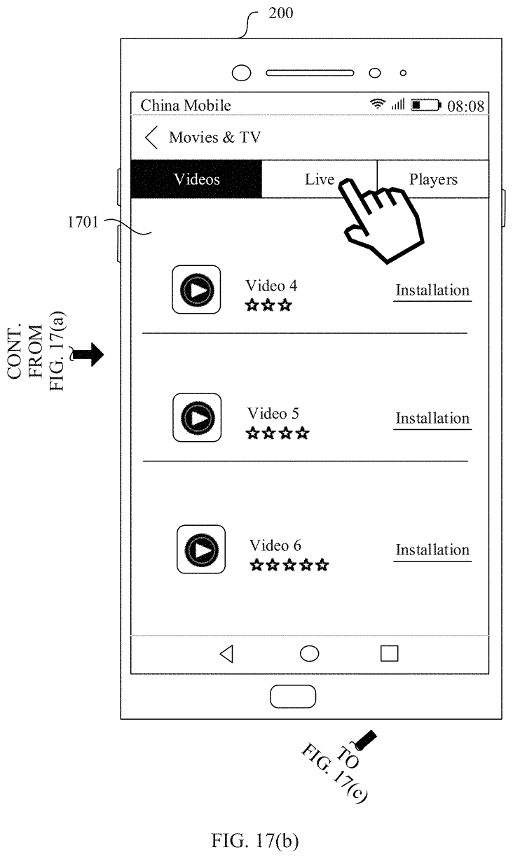

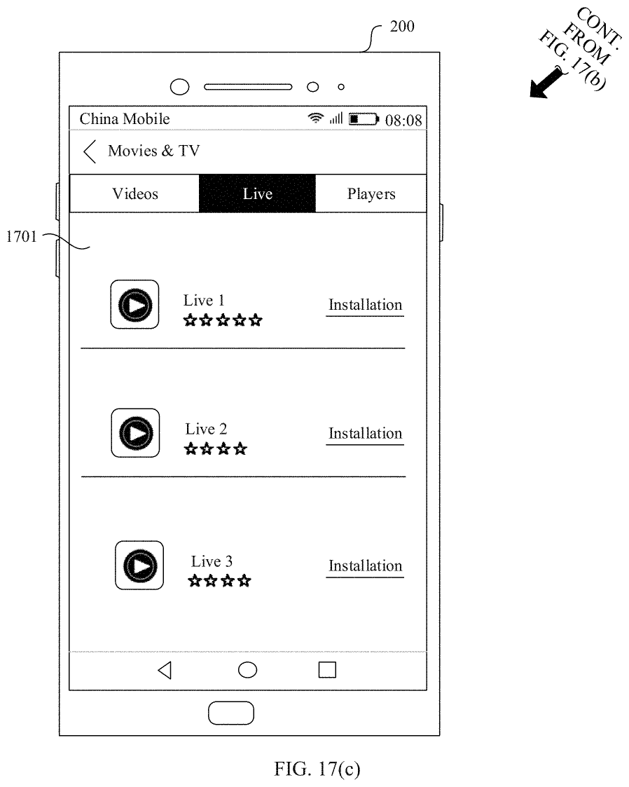

For example, the first application is an application store. The first screen may be a category screen of the application store. For example, the first screen is a Movies & TV category screen of an application store of a mobile phone 200 shown in FIG. 17(a). The Movies & TV category screen includes a “Movies & TV” sub-screen 1701. Recommendation information of different types of Movies & TV applications may be displayed on the “Movies & TV” sub-screen 1701. For example, recommendation information of a video-type Movies & TV application is displayed on a “Movies & TV” sub-screen 1701 shown in FIG. 17(a). Recommendation information of a live-type Movies & TV application is displayed on a “Movies & TV” sub-screen 1701 shown in FIG. 17(c). Certainly, recommendation information of a player-type Movies & TV application may be further displayed on the “Movies & TV” sub-screen 1701.

As shown in FIG. 17(a), first display content currently displayed on the “Movies & TV” sub-screen 1701 is application recommendation information of a video 1, a video 2, and a video 3. In this embodiment of this application, the video 1 refers to an application of the video 1, the video 2 refers to an application of the video 2, and the video 3 refers to an application of the video 3.

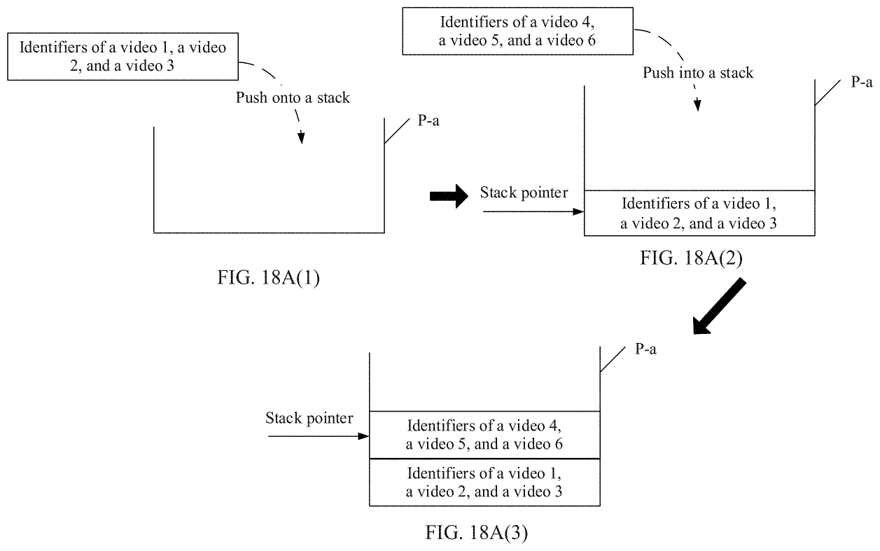

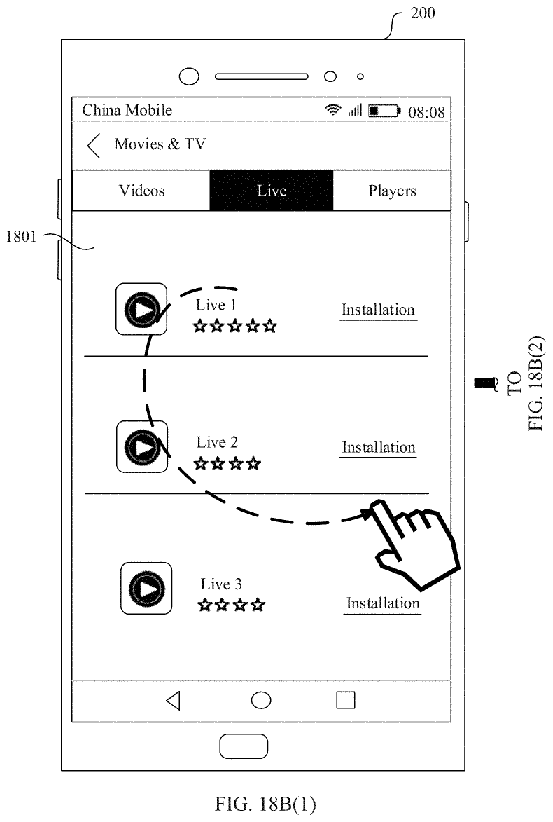

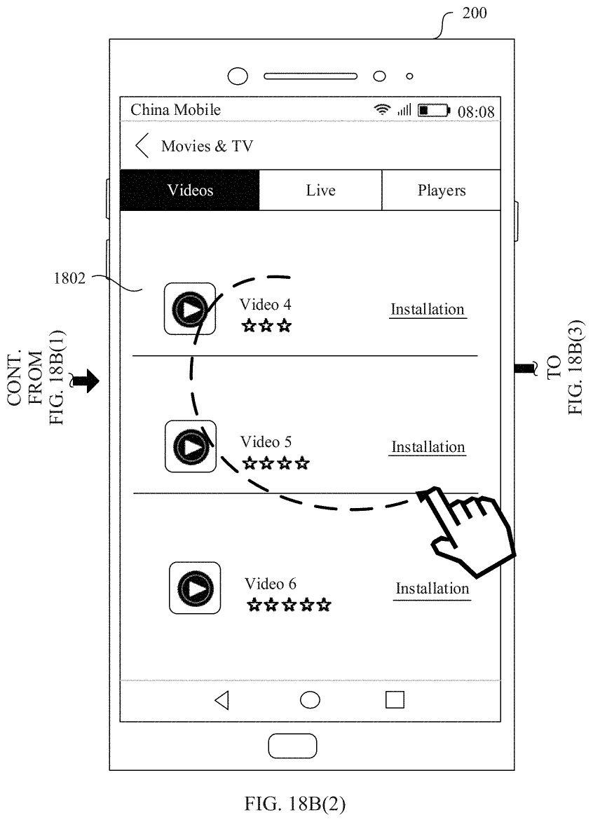

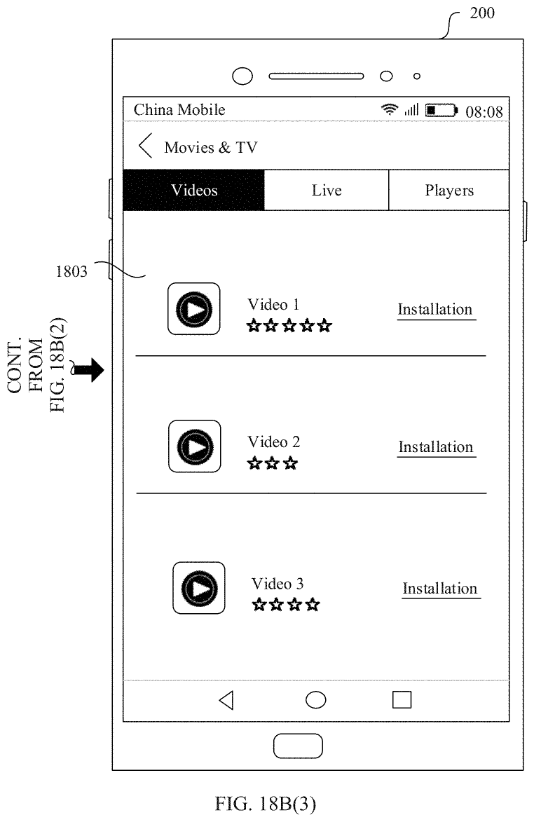

The mobile phone 200 receives a first operation (for example, an S-shaped gesture) performed by the user on the “Movies & TV” sub-screen 1701 shown in FIG. 17(a). The mobile phone 200 may refresh the display content on the “Movies & TV” sub-screen 1701 in response to the S-shaped gesture. It is assumed that refreshed second display content includes application recommendation information of a video 4, a video 5, and a video 6. As shown in FIG. 17(b), the mobile phone 200 displays the “application recommendation information of a video 4, a video 5, and a video 6” on the “Movies & TV” sub-screen 1701. In addition, the mobile phone 200 may push “identifiers of a video 1, a video 2, and a video 3” onto a preset stack P-a shown in FIG. 18A(1), to obtain a preset stack P-a shown in FIG. 18A(2).

In this embodiment of this application, the first operation may alternatively be an operation used to switch a type of display content on the first sub-screen. The display content on the first sub-screen changes after the terminal switches the type of the display content on the first sub-screen in response to the first operation. Therefore, the terminal may refresh the display content on the first sub-screen in response to the first operation. For example, the first operation may be a tap operation performed by the user on a “live” option shown in FIG. 17(b).

As shown in FIG. 17(c), the mobile phone 200 displays “application recommendation information of live 1, live 2, and live 3” on the “Movies & TV” sub-screen 1701 in response to the tap operation performed by the user on the “live” option shown in FIG. 17(b). In addition, the mobile phone 200 may push “identifiers of a video 4, a video 5, and a video 6” onto the preset stack P-a shown in FIG. 18A(2), to obtain a preset stack P-a shown in FIG. 18A(3).

In the application scenario (3), the display content on the first sub-screen changes in response to a second operation. In addition, display content (namely, the second display content) displayed before the change and display content (namely, the first display content) displayed after the change may be a same type of display content, or may be different types of display content.

For example, the second operation is a semi-circular gesture. As shown in FIG. 18B(1), “application recommendation information of live 1, live 2, and live 3” is currently displayed on a first sub-screen 1801 of the mobile phone 200. The mobile phone 200 receives a semi-circular gesture entered by the user on the first sub-screen 1801 shown in FIG. 18B(1). The mobile phone 200 displays, in response to the semi-circular gesture on a first sub-screen 1802 shown in FIG. 18B(2), “application recommendation information of a video 4, a video 5, and a video 6” corresponding to the “identifiers of a video 4, a video 5, and a video 6” to which a stack pointer shown in FIG. 18A(3) points.

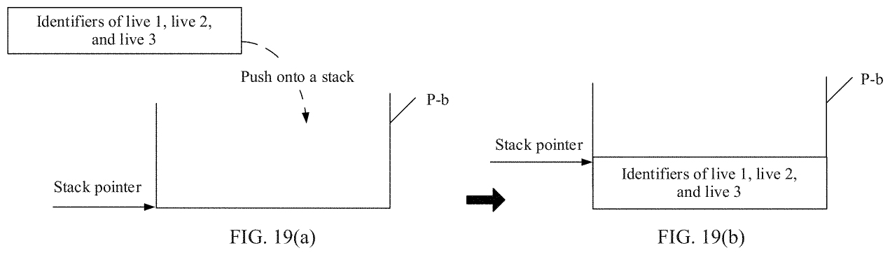

In the implementation (1), a plurality of preset stacks are in a one-to-one correspondence with a plurality of types of display content. Each preset stack stores a display record of one type of display content. For example, the display content shown in FIG. 17(a) to FIG. 17(c) or FIG. 18B(1) to FIG. 18B(3) may include three types: a video type, a live type, and a player type. The terminal may store a display record of video-type display content in a preset stack. For example, the preset stack P-a shown in FIG. 18A(1) to FIG. 18A(3) is a video-type preset stack, and is configured to store a display record of video-type display content. The terminal stores a display record of live-type display content in another preset stack. For example, a preset stack P-b shown in FIG. 19(a) and FIG. 19(b) is a live-type preset stack, and is configured to store a display record of live-type display content.

In the implementation (1), in response to the semi-circular gesture entered by the user on the first sub-screen 1801 shown in FIG. 18B(1), the mobile phone 200 may push identifiers, namely, “identifiers of live 1, live 2, and live 3”, of the second display content onto a preset stack P-b shown in FIG. 19(a), to obtain a preset stack P-b shown in FIG. 19(b), instead of pushing the “identifiers of live 1, live 2, and live 3” onto the preset stack P-a shown in FIG. 18A(3). In this case, the stack pointer points to the “identifiers of live 1, live 2, and live 3” on a stack top.

In the implementation (2), display records of a plurality of types of display content displayed on the first sub-screen are stored in a preset stack. For example, the display content shown in FIG. 17(a) to FIG. 17(c) or FIG. 18B(1) to FIG. 18B(3) may include three types: a video type, a live type, and a player type. The terminal may store a display record of video-type display content, a display record of live-type display content, and a display record of player-type display content in a preset stack.

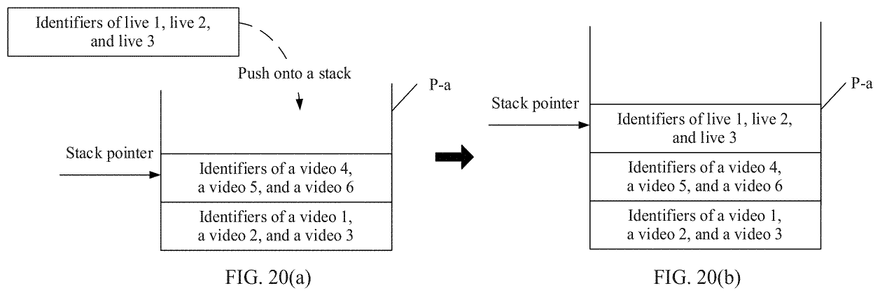

In the implementation (2), in response to the semi-circular gesture entered by the user on the first sub-screen 1801 shown in FIG. 18B(1), the mobile phone 200 may push identifiers, namely, “identifiers of live 1, live 2, and live 3”, of the second display content onto a preset stack P-a shown in FIG. 20(a), namely, the preset stack P-a shown in FIG. 18A(3), to obtain a preset stack P-a shown in FIG. 20(b). The preset stack P-a shown in FIG. 20(b) includes display records of video-type display content, for example, the “identifiers of a video 1, a video 2, and a video 3” and the “identifiers of a video 4, a video 5, and a video 6”. The preset stack P-a shown in FIG. 20(b) may further include a display record of live-type display content, for example, the “identifiers of live 1, live 2, and live 3”.

In an implementation (2), the display content on the first sub-screen changes in response to the second operation. In addition, display content (namely, the second display content) displayed before the change and display content (namely, the first display content) displayed after the change may be a same type of display content, or may be different types of display types.

For example, the second operation is a semi-circular gesture. The “application recommendation information of live 1, live 2, and live 3” (live-type display content) shown in FIG. 18B(1) and the “application recommendation information of a video 4, a video 5, and a video 6” (video-type display content) shown in FIG. 18B(2) are different types of display content.

The mobile phone 200 receives a semi-circular gesture entered by the user on the first sub-screen 1802 shown in FIG. 18B(2). The mobile phone 200 displays, in response to the semi-circular gesture, “application recommendation information of a video 1, a video 2, and a video 3” shown in FIG. 18B(3), The “application recommendation information of a video 4, a video 5, and a video 6” (video-type display content) shown in FIG. 18B(2) and the “application recommendation information of a video 1, a video 2, and a video 3” (video-type display content) shown in FIG. 18B(3) are a same type of display content.

### Application Scenario (4)

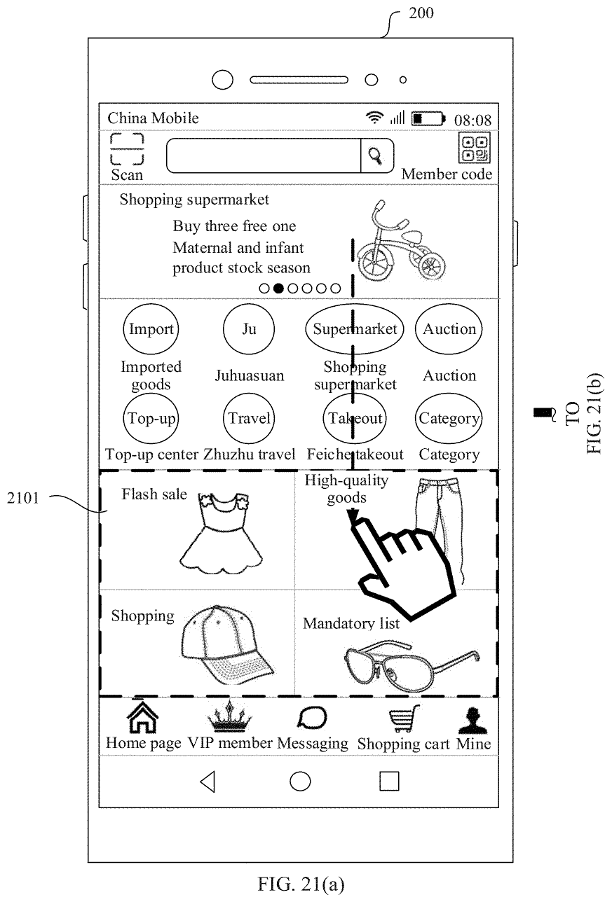

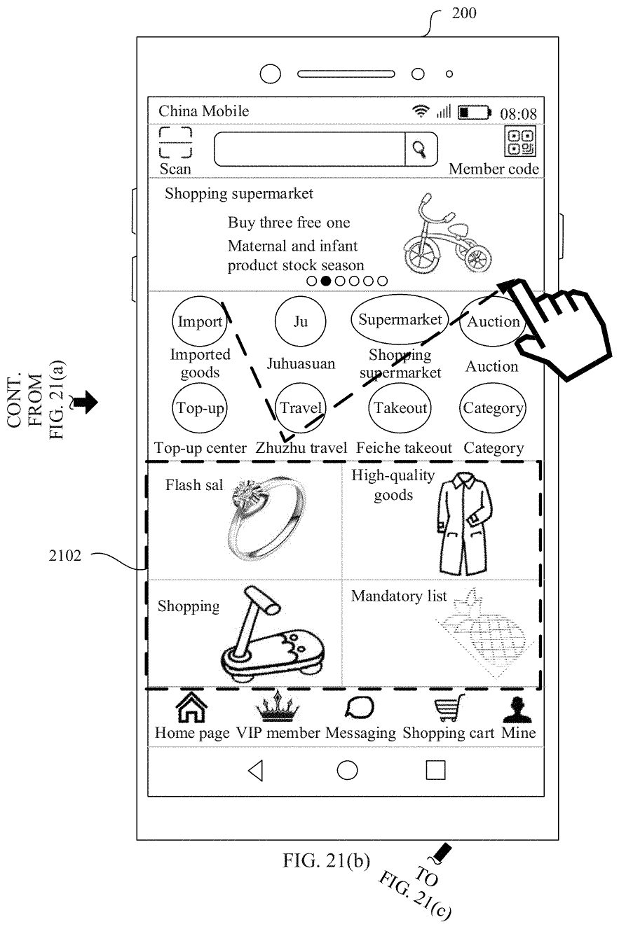

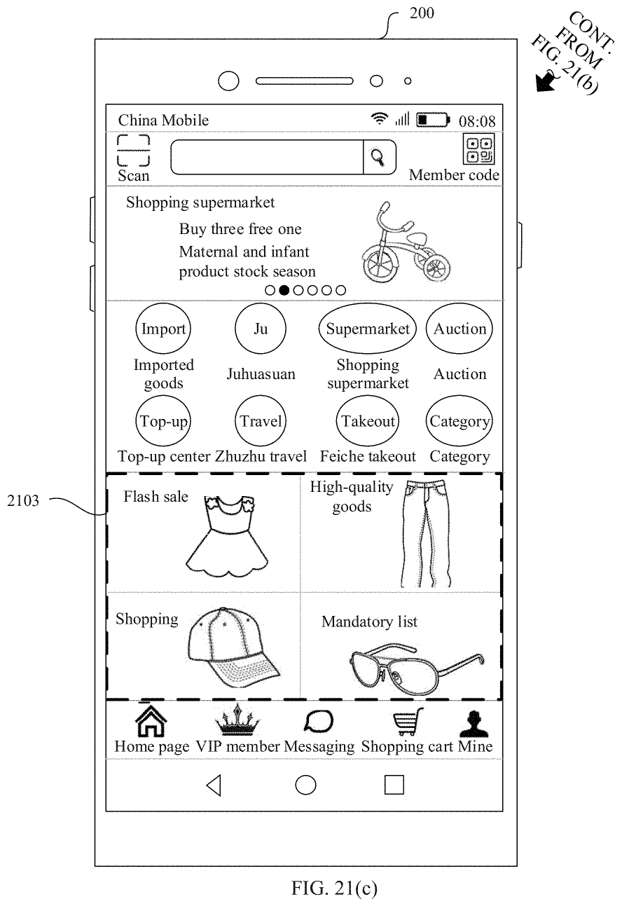

For example, the first application is Taohao. The first screen may be a display screen of Taobao. For example, the first screen is a display screen shown in FIG. 21(a). The display screen shown in FIG. 21(a) includes a first sub-screen 2101. First display content on the first sub-screen 2101 shown in FIG. 21(a) includes recommendation information of a plurality of commodities, for example, “recommendation information of Skirt, Pants, Hat, and Glasses”.

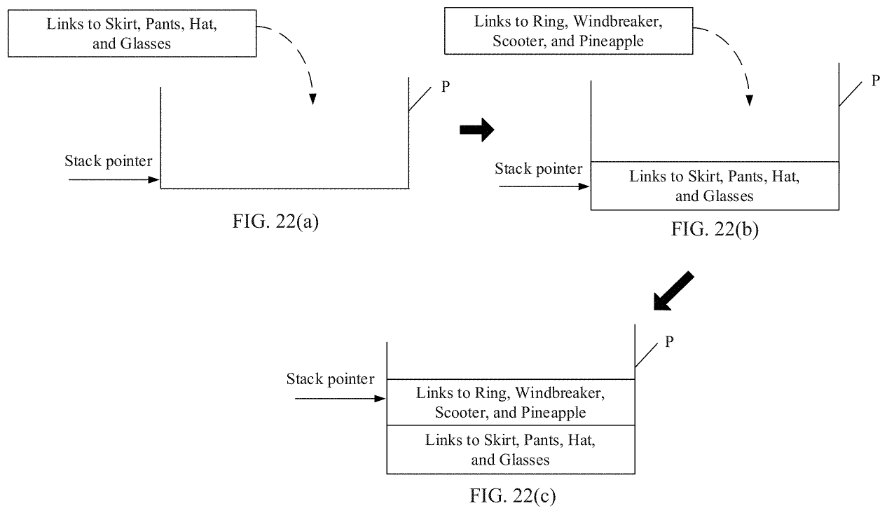

For example, a first operation is a pull-down gesture entered by the user on the first sub-screen 2101. The mobile phone 200 may refresh display content on the first sub-screen 2101 in response to the pull-down gesture entered by the user on the first sub-screen 2101 shown in FIG. 21(a). It is assumed that refreshed second display content includes “recommendation information of Ring, Windbreaker, Scooter, and Pineapple”. As shown in FIG. 21(b), the mobile phone 200 displays the second display content, that is, the “recommendation information of Ring, Windbreaker, Scooter, and Pineapple”, on a first sub-screen 2102. In addition, in response to the pull-down gesture, the mobile phone 200 may push the first display content “links to Skirt, Pants, Hat, and Glasses” onto a preset stack P shown in FIG. 22(a), to obtain a preset stack P shown in FIG. 22(b). In this embodiment of this application, the link in the application scenario (4) is a commodity link in the first application.

For example, a second operation is a tick gesture entered by the user on the first sub-screen 2102. The mobile phone 200 may redisplay, in response to the tick gesture entered by the user on the first sub-screen 2102 shown in FIG. 21(b), the first display content, namely, the “recommendation information of Skirt, Pants, Hat, and Glasses” on a first sub-screen 2103 shown in FIG. 21(c). In addition, in response to the tick gesture, the mobile phone 200 may further push “links to Ring, Windbreaker, Scooter, and Pineapple” onto the preset stack P shown in FIG. 22(b), to obtain a preset stack P shown in FIG. 22(c).

An embodiment of this application further provides a display control method. Different from the foregoing display control method, in the display control method, the terminal stores updated display content (for example, second display content) in response to a first operation. Specifically, the display control method may include the following content:

The terminal displays a first screen, where first display content is currently displayed on the first screen. A first display record of the first display content is stored in the terminal when the terminal displays the first display content. The terminal receives a first operation performed by a user on the first display content, where the first operation is an operation of updating the first display content. The terminal updates the first display content displayed on the first screen to second display content, and stores a second display record corresponding to the second display content, in response to the first operation. The first display content is different from the second display content. The terminal receives a second operation performed by the user on the second display content, where the second operation is an operation of viewing the display content displayed before the update. The terminal displays the first display content on the first screen based on the first display record in response to the second operation. Optionally, the first display content and the second display content may be displayed on a first sub-screen in the first screen.

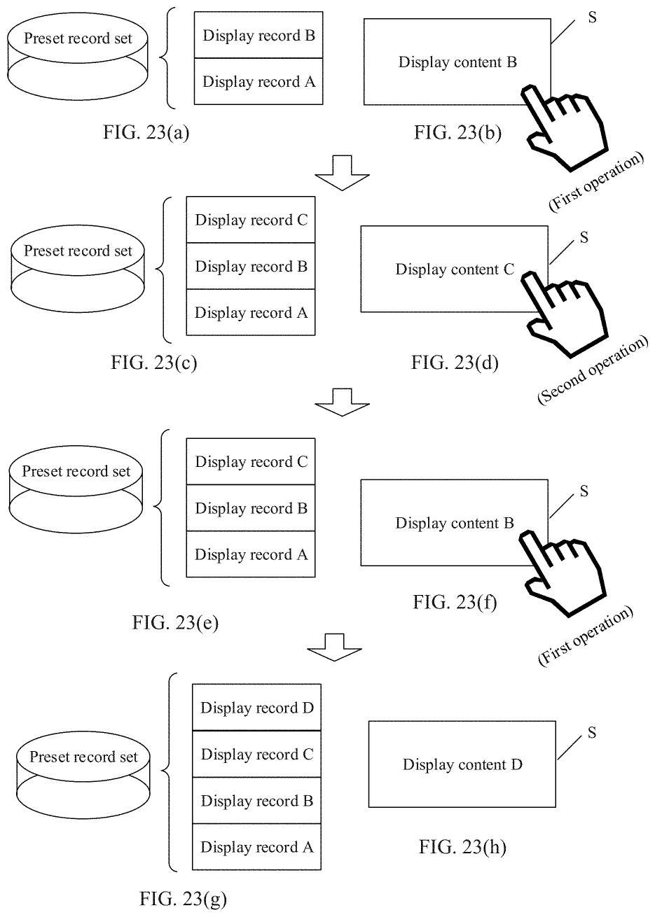

In this embodiment of this application, the display control method provided in this embodiment of this application is described herein by using an example in which a sub-screen S shown in FIG. 23(a) to FIG. 23(h) is the first sub-screen displayed by the terminal.

As shown in FIG. 23(b), it is assumed that display content B is currently displayed on the sub-screen S. To be specific, the display content B shown in FIG. 23(b) is first display content. A preset record set shown in FIG. 23(a) stores a display record A and a display record B. The display record A corresponds to display content A, and the display record B corresponds to the display content B. The terminal updates, in response to a refresh operation (a first operation) performed by the user on the sub-screen S shown in FIG. 23(b), the display content B displayed on the sub-screen S to display content C shown in FIG. 23(d). The display content C shown in FIG. 23(d) is second display content. In addition, as shown in FIG. 23(c), the terminal may store, in response to the first operation, a display record C of the display content C in a preset record set.

It is assumed that a second operation is used to instruct the terminal to display display content displayed before the sub-screen S is latest refreshed. For example, as shown in FIG. 23(b), display content on the sub-screen is C after the latest refresh. As shown in FIG. 23(d), display content on the sub-screen is B before the latest refresh. In this case, the terminal may display, on the sub-screen S in response to a second operation performed by the user on the sub-screen S shown in FIG. 23(d), the display content B (namely, the first display content) shown in FIG. 23(f). It should be noted that because the second operation is not an operation used to refresh the sub-screen S, compared with the preset record set shown in FIG. 23(c), no new display record is added to a preset record set shown in FIG. 23(e). Correspondingly, if the terminal receives a second operation performed by the user on the sub-screen S shown in FIG. 23(f), the terminal may display the display content A (not shown in FIG. 23) on the sub-screen S.

In some embodiments, after redisplaying the first display content on the first sub-screen, the terminal may receive the first operation (a refresh operation) performed by the user on the first sub-screen on which the first display content is displayed. In this case, the terminal may update, in response to the first operation, the first display content displayed on the first sub-screen to third display content.

For example, the terminal receives a first operation performed by the user on the sub-screen S shown in FIG. 23(f). The terminal may update, in response to the first operation, the display content B displayed on the sub-screen S to display content D. In other words, the terminal displays, on the sub-screen S, the display content D shown in FIG. 23(h). In addition, in response to the first operation, the terminal may store a display record D of the display content D in the preset record set shown in FIG. 23(e), to obtain a preset record set shown in FIG. 23(g). Compared with the preset record set shown in FIG. 23(e), a new display record D is added to the preset record set shown in FIG. 23(g).

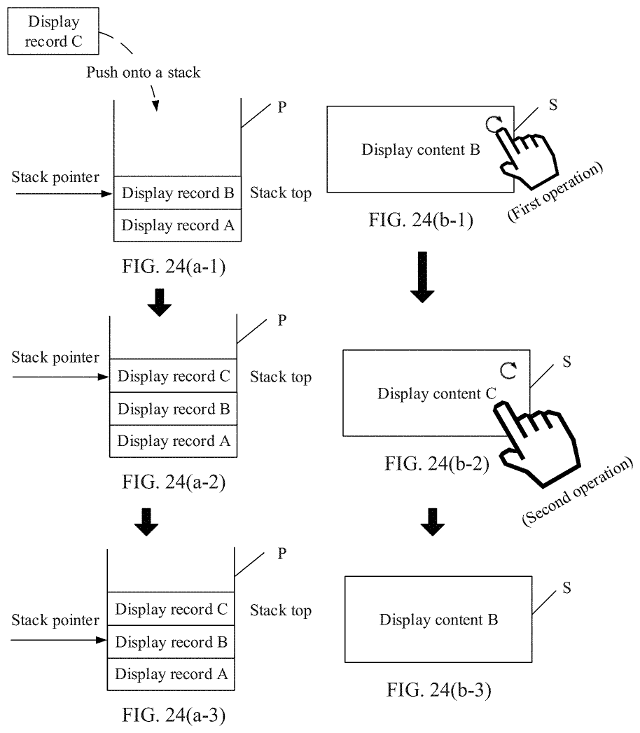

Optionally, the preset record set may be a preset stack. The terminal may display, on the first sub-screen, display content corresponding to a display record to which a stack pointer of the preset stack points. In this embodiment of this application, an example in which a sub-screen S shown in FIG. 24(a-1) to FIG. 24(a-3) and FIG. 24(b-1) to FIG. 24(b-3) is the first sub-screen displayed by the terminal is used herein to describe a specific process of implementing, by using a preset stack, the display control method provided in this embodiment of this application.

As shown in FIG. 24(b-1), it is assumed that display content B is currently displayed on the sub-screen S. To be specific, the display content B shown in FIG. 24(b-1) is first display content. A display record A and a display record B are pushed onto a preset stack P shown in FIG. 24(a-1). The display record A corresponds to display content A, and the display record B corresponds to the display content B. The terminal receives a first operation (for example, a tap operation performed by the user on a refresh key on the sub-screen S) performed by the user on the sub-screen S shown in FIG. 24(b-1). In response to the first operation, the terminal may push a display record C onto the preset stack P shown in FIG. 24(a-1), to obtain a preset stack P shown in FIG. 24(a-2). The display record C corresponds to display content C. In the preset stack P shown in FIG. 24(a-2), a stack pointer points to the display record C on a stack top. The terminal may update, in response to the first operation, the display content B displayed on the sub-screen S to the display content C to which the stack pointer shown in FIG. 24(a-2) points. In other words, the display content C shown in FIG. 24(b-2) is displayed on the sub-screen S. The display content C shown in FIG. 24(b-2) is second display content.

It is assumed that a second operation may be used to instruct the terminal to display display content displayed before the sub-screen S is latest refreshed. For example, when the second operation is a double-tap operation performed by the user on the sub-screen S, the second operation may be used to instruct the terminal to display the display content displayed before the sub-screen S is latest refreshed. For example, as shown in FIG. 24(b-2), display content on the sub-screen is C after the latest refresh. As shown in FIG. 24(b-1), display content on the sub-screen is B before the latest refresh. To be specific, the second operation corresponds to the display content B. In this case, as shown in FIG. 24(a-3), the terminal may control, in response to the second operation performed by the user on the sub-screen S shown in FIG. 24(b-2), the stack pointer to point to the display record B. As shown in FIG. 24(b-3), the terminal may redisplay, on the sub-screen S in response to the second operation, the display content B to which the stack pointer shown in FIG. 24(a-3) points.

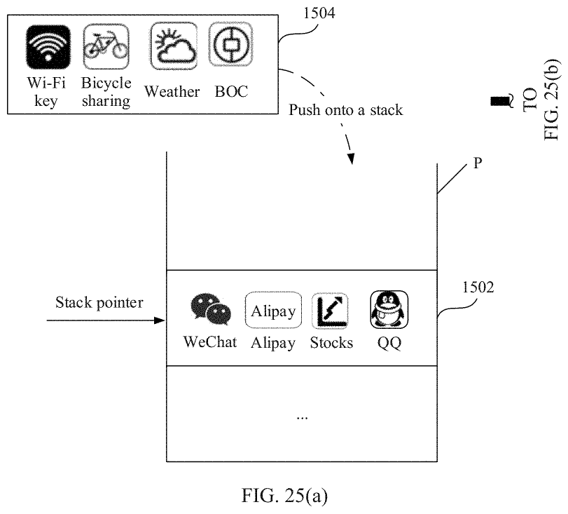

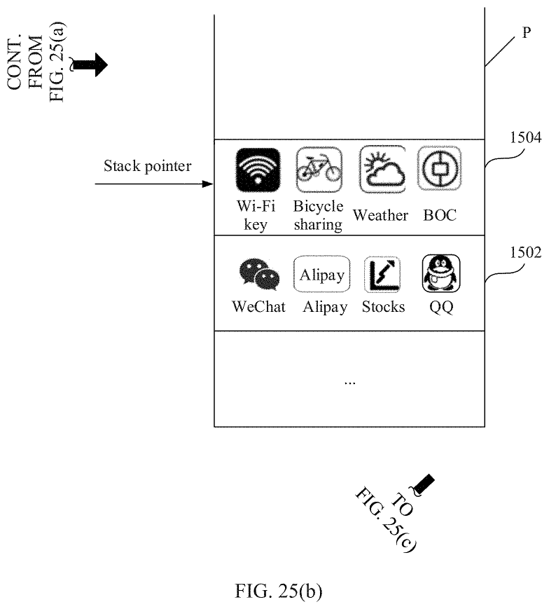

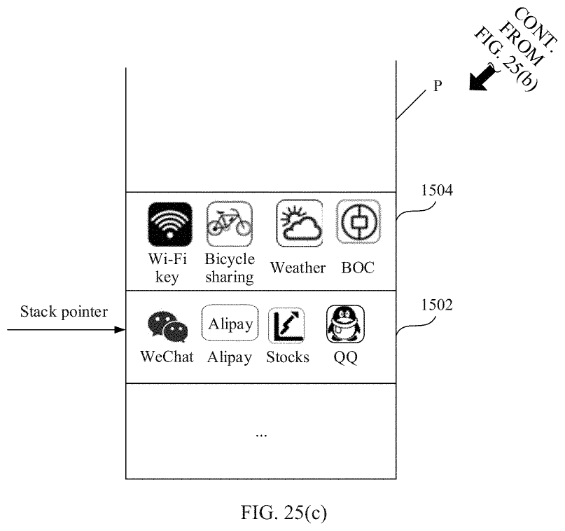

With reference to the foregoing application scenario (2), as shown in FIG. 15(a), the home page of the application store includes the first sub-screen, namely, the “application recommendation” sub-screen 1501. The first display content 1502 is displayed on the “application recommendation” sub-screen 1501. The first display content 1502 includes the application icons of WeChat, Alipay, Stocks, and QQ. In this case, as shown in FIG. 25(a), the first display content 1502 is stored in and pushed onto a preset stack P.

For example, the first operation is the tap operation performed by the user on the refresh key 1503 on the “application recommendation” sub-screen 1501. The mobile phone 200 may refresh the display content on the “application recommendation” sub-screen 1501 in response to the tap operation performed by the user on the refresh key 1503. Assuming that the refreshed second display content 1504 includes the application icons of Wi-Fi key, Bicycle sharing, Weather, and BOC, as shown in FIG. 25(b), the mobile phone 200 may push the second display content 1504 onto the preset stack P shown in FIG. 25(a). In this case, the stack pointer points to the second display content 1504 on the stack top. As shown in FIG. 15(b), the mobile phone 200 displays, on the “application recommendation” sub-screen 1501, the second display content 1504 to which the stack pointer points.

For example, the second operation is the left-to-right slide operation performed by the user on the “application recommendation” sub-screen 1501. As shown in FIG. 15(b), when the finger of the user slides on the “application recommendation” sub-screen 1501, the mobile phone 200 may display the navigation bar 1505 on the “application recommendation” sub-screen 1501. The stack pointer switches between the display records in the preset stack in response to the drag operation performed by the user on the navigation key in the navigation bar 1505. For example, when the finger of the user drags the navigation key in the navigation bar 1505 from the location shown in FIG. 15(c) to the location shown in FIG. 15(d), the stack pointer of the preset stack P points to the first display content 1502 shown in FIG. 25(c). In other words, the first display content 1502 is redisplayed on the “application recommendation” sub-screen 1501 shown in FIG. 15(d).

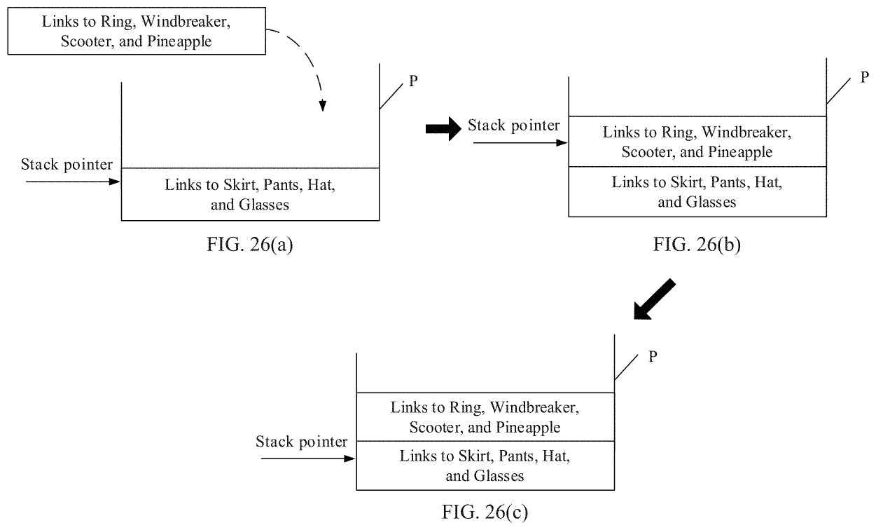

With reference to the foregoing application scenario (4), the first display content on the first sub-screen 2101 shown in FIG. 21(a) includes the recommendation information of the plurality of commodities, for example, the “recommendation information of Skirt, Pants, Hat, and Glasses”. In this case, as shown in FIG. 26(a), the first display content “links to Skirt, Pants, Hat, and Glasses” is stored in and pushed onto a preset stack P.

For example, the first operation is the pull-down gesture entered by the user on the first sub-screen 2101. The mobile phone 200 may refresh the display content on the first sub-screen 2101 in response to the pull-down gesture entered by the user on the first sub-screen 2101 shown in FIG. 21(a). It is assumed that the refreshed second display content includes the “recommendation information of Ring, Windbreaker, Scooter, and Pineapple”. In response to the pull-down gesture, the mobile phone 200 may push webpage links, namely, the “links to Ring, Windbreaker, Scooter, and Pineapple”, to the second display content onto the preset stack P shown in FIG. 26(a), to obtain a preset stack P shown in FIG. 26(b). In this case, the stack pointer points to the “links to Ring. Windbreaker, Scooter, and Pineapple” on the stack top. As shown in FIG. 21(b), the mobile phone 200 displays, on the first sub-screen 2102, the “recommendation information of Ring, Windbreaker, Scooter, and Pineapple” corresponding to the “links to Ring, Windbreaker, Scooter, and Pineapple” to which the stack pointer points. For example, the second operation is the tick gesture entered by the user on the first sub-screen 2101. The mobile phone 200 controls, in response to the tick gesture entered by the user on the first sub-screen 2101 shown in FIG. 21(b), the stack pointer to perform the “links to Skirt, Pants, Hat, and Glasses” shown in FIG. 26(c). As shown in FIG. 21(C), the mobile phone 200 displays, on the first sub-screen 2103, the “recommendation information of Skirt, Pants, Hat, and Glasses” corresponding to the “links to Skirt, Pants, Hat, and Glasses” to which the stack pointer shown in FIG. 26(c) points.

It may be understood that to implement the foregoing functions, the terminal includes corresponding hardware structures and/or software modules for performing the functions. A person skilled in the art should be easily aware that units, algorithms, and steps in the examples described with reference to the embodiments disclosed in this specification may be implemented by hardware or a combination of hardware and computer software in the embodiments of this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the embodiments of this application.

In the embodiments of this application, the terminal may be divided into function modules based on the foregoing method examples. For example, function modules corresponding to the functions may be obtained through division, or two or more functions may be integrated into one processing module. The integrated module may be implemented in a form of hardware, or may be implemented in a form of a software function module. It should be noted that in the embodiments of this application, division into the modules is an example and is merely logical function division, and may be other division in an actual implementation.

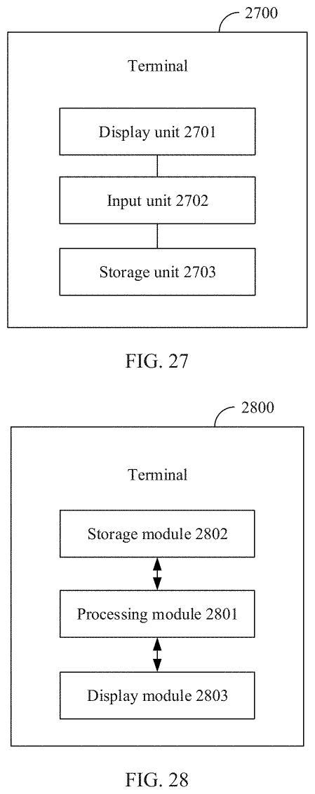

When each function module is obtained through division based on each corresponding function, as shown in FIG. 27, an embodiment of this application provides a terminal 2700. The terminal 2700 includes a display unit 2701, an input unit 2702, and a storage unit 2703.

The display unit 2701 is configured to support the terminal 2700 in performing S1202 and the operation of “displaying the second display content” in S301, S305, S803, and S303 in the foregoing method embodiments, and/or is configured to perform another process of the technology described in this specification. The input unit 2702 is configured to support the terminal 2700 in performing S302, S304, S802, and S1201 in the foregoing method embodiments, and/or is configured to perform another process of the technology described in this specification. The storage unit 2703 is configured to support the terminal 2700 in performing S801, S1203, and the operation of “storing the first display record” in S303 in the foregoing method embodiments, and/or is configured to perform another process of the technology described in this specification.

It should be noted that functions of the display unit 2701, the input unit 2702, and the storage unit 2703 include but are not limited to functions of performing the foregoing method steps. The display unit 2701, the input unit 2702, and the storage unit 2703 may be configured to support the terminal 2700 in performing all functions described in the foregoing method embodiments. For example, the display unit 2701 may be further configured to display a navigation bar on a first sub-screen in response to a second operation.

The terminal 2700 may further include a receiving unit and a sending unit. The receiving unit is configured to receive information sent by another device. The sending unit is configured to send information to the another device.

When an integrated unit is used, the input unit 2702 may be implemented in one processing module. The receiving unit and the sending unit may be integrated into one communications module for implementation. The display unit 2701 may be a display module. The storage unit 2703 may be a storage module. FIG. 28 is a possible schematic structural diagram of the terminal in the foregoing embodiments. The terminal 2800 includes a processing module 2801, a storage module 2802, and a display module 2803.

The processing module 2801 is configured to: control and manage the terminal 2800. The display module 2803 is configured to: display a screen and receive a touch operation of a user. The storage module 2802 is configured to store program code and data that are of the terminal 2800. The terminal 2800 may further include a communications module, and the communications module is configured to communicate with another device. For example, the communications module is configured to: receive or send information from or to the another device.

The processing module 2801 may be a processor or a controller, for example, may include a central processing unit (Central Processing Unit, CPU) and a graphics processing unit (Graphics Processing Unit, GPU), a general purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. The processing module 2801 may implement or execute various example logical blocks, modules, and circuits described with reference to content disclosed in this application. The processor may be a combination of processors implementing a computing function, for example, a combination of one or more microprocessors, or a combination of a DSP and a microprocessor. The communications module may be a transceiver, a transceiver circuit, a communications interface, or the like. The storage module 2802 may be a memory.

When the processing module 2801 is a processor (for example, the processor 201 shown in FIG. 2), the communications module is a radio frequency circuit (for example, the radio frequency circuit 202 shown in FIG. 2), the storage module 2802 is a memory (for example, the memory 203 shown in FIG. 2), and the display module 2803 is a display (including the touchscreen 204 that includes the touch-sensitive surface 204-2 and the display panel 204-5 shown in FIG. 2), the device provided in this application may be the mobile phone 200 shown in FIG. 2. The communications module may not only include the radio frequency circuit, but also include a Wi-Fi module and a Bluetooth module. The communications modules such as the radio frequency circuit, the Wi-Fi module, and the Bluetooth module may be collectively referred to as a communications interface. The processor, the communications interface, the touchscreen, and the memory may be coupled together by using a bus.

An embodiment of this application further provides a computer storage medium. The computer storage medium stores computer program code, and when the foregoing processor executes the computer program code, the terminal performs related method steps in any one of FIG. 3, FIG. 8A, and FIG. 12A to implement the method in the foregoing embodiment.

An embodiment of this application further provides a computer program product. When the computer program product is run on a computer, the computer is enabled to perform related method steps in any one of FIG. 3, FIG. 8A, and FIG. 12A to implement the method in the foregoing embodiment.

The terminal 2700, the terminal 2800, the computer storage medium, and the computer program product provided in this application each are configured to perform the corresponding method provided above. Therefore, for beneficial effects that can be achieved by the terminal 2700, the terminal 2800, the computer storage medium, and the computer program product, refer to the beneficial effects in the corresponding method provided above. Details are not described herein again.

In the descriptions in the foregoing implementations, a person skilled in the art may clearly understand that for the purpose of convenient and brief description, division into the foregoing function modules is merely used as an example for description. In actual application, the foregoing functions can be allocated to different modules for implementation based on a requirement. To be specific, an inner structure of an apparatus is divided into different function modules to implement all or some of the functions described above. For a detailed working process of the foregoing described system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiment is merely an example. For example, division into the modules or units is merely logical function division and may be other division in an actual implementation. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may or may not be physically separate, and parts displayed as units may or may not be physical units, and may be located in one position, or may be distributed on a plurality of network units. Some or all of the units may be selected based on an actual requirement to achieve the objectives of the solutions of the embodiments.

In addition, function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer readable storage medium. Based on such an understanding, the technical solutions in this application essentially, or the part contributing to the prior art, or all or some of the technical solutions may be implemented in a form of a computer software product. The computer software product is stored in a storage medium and includes several instructions for instructing a computer device (which may be a personal computer, a server, a network device, or the like) or a processor to perform all or some of the steps of the methods in the embodiments of this application. The foregoing storage medium includes any medium that can store program code, such as a flash memory, a removable hard disk, a read-only memory, a random access memory, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A display control method implemented by a terminal, wherein the display control method comprises:
displaying a first screen comprising first display content;
storing a first display record corresponding to the first display content;
receiving a first operation from a user on the first display content updating, in response to the first operation, the first display content to second display content, wherein the first display content is different from the second display content;
receiving a second operation from the user on the second display content; and
displaying, in response to the second operation, the first display content on the first screen based on the first display record in response to the second operation.

2. The display control method of claim 1, wherein the first screen comprises one or more sub-screens, wherein the one or more sub-screens comprise a first sub-screen, wherein the first display content is displayed on the first sub-screen and wherein the display control method further comprises displaying, in response to the first operation, the second display content is displayed on the first sub-screen.

3. The display control method of claim 1, wherein the first display record comprises either:
the first display content or a first identifier of the first display content; or
the first display content or the first identifier, and first layout information of the first display content on the first screen.

4. The display control method of claim 1, further comprising storing, in response to the second operation, a second display record corresponding to the second display content, wherein the second display record comprises either:
the second display content or a second identifier of the second display content; or
the second display content or the second identifier, and second layout information of the second display content on the first screen.

5. The display control method of claim 2, wherein a preset record set stores display records on the first sub-screen in a time sequence, wherein the display records comprise the first display record, and wherein the display control method further comprises:
obtaining, from the preset record set, the first display record that is stored latest in the preset record set;
determining the first display content based on the first display record; and
displaying, in response to the second operation, the first display content on the first sub-screen.

6. The display control method of claim 5, wherein the preset record set is a preset stack, and wherein the display control method further comprises pushing, in response to the first operation, the first display record onto the preset stack.

7. The display control method of claim 6, wherein a stack pointer of the preset stack points to a display record on a stack top of the preset stack in response to the first operation, and wherein the display control method further comprises:
obtaining, in response to the second operation, the first display record to which the stack pointer points;
determining the first display content based on the first display record;
displaying the first display content on the first sub-screen; and
pushing a second display record onto the preset stack.

8. The display control method of claim 7, wherein the second operation is a slide operation, wherein the stack pointer switches between the display records in the preset stack as a sliding location of the slide operation changes, and wherein a corresponding display content on the first sub-screen changes with switching of the stack pointer.

9.-21. (canceled)

22. A terminal comprising:
a display; and
a processor coupled to the display and configured to:
display, using the display, a first screen comprising first display content;
store a first display record corresponding to the first display content;
receive a first operation from a user on the first display content;
update, in response to the first operation, the first display content to second display content, wherein the first display content is different from the second display content;
receive a second operation from the user on the second display content; and
display, using the display in response to the second operation, the first display content on the first screen based on the first display record.

23. A computer program product comprising computer-executable instructions stored on a non-volatile computer storage medium that, when executed by a processor, cause an apparatus to:
display a first screen comprising first display content;
store a first display record corresponding to the first display content;
receive a first operation from a user on the first display content;
update, in response to the first operation, the first display content to second display content, wherein the first display content is different from the second display content;
receive a second operation from the user on the second display content; and
display, in response to the second operation, the first display content on the first screen based on the first display record.

24. (canceled)

25. The display control method of claim 1, wherein the first screen comprises a digital assistant.

26. The display control method of claim 2, wherein the first sub-screen comprises one of an application recommendation sub-screen, a video recommendation sub-screen, or a music recommendation sub-screen.

27. The terminal of claim 22, wherein the first screen comprises one or more sub-screens, wherein the one or more sub-screens comprise a first sub-screen, wherein the first display content is displayed on the first sub-screen, and wherein the processor is further configured to display, using the display in response to the first operation, the second display content on the first sub-screen.

28. The terminal of claim 22, wherein the first display record comprises either:
the first display content or a first identifier of the first display content; or
the first display content or the first identifier, and first layout information of the first display content on the first screen.

29. The terminal of claim 22, wherein the processor is further configured to store, in response to the second operation, a second display record corresponding to the second display content, wherein the second display record comprises either:
the second display content or a second identifier of the second display content; or
the second display content or the second identifier, and second layout information of the second display content on the first screen.

30. The terminal of claim 27, wherein a preset record set stores display records on the first sub-screen in a time sequence, wherein the display records comprise the first display record, and wherein the processor is further configured to:
obtain the first display record that is stored latest in the preset record set from the preset record set;
determine the first display content based on the first display record; and
display, in response to the second operation, the first display content on the first sub-screen.

31. The terminal of claim 30, wherein the preset record set is a preset stack, and wherein the processor is further configured to push, in response to the first operation, the first display record onto the preset stack.

32. The terminal of claim 31, wherein a stack pointer of the preset stack points to a display record on a stack top of the preset stack in response to the first operation, and wherein the processor is further configured to:
obtain, in response to the second operation, the first display record to which the stack pointer points;
determine the first display content based on the first display record;
display, using the display, the first display content on the first sub-screen; and
push a second display record onto the preset stack.

33. The terminal of claim 22, wherein the first screen comprises HIBOARD.

34. The terminal of claim 27, wherein the first sub-screen comprises one of an application recommendation sub-screen, a video recommendation sub-screen, or a music recommendation sub-screen.
